(19) United States
(12) Patent Application Publication
(10) Pub. No.: US 2011/0114669 A1
(43) Pub. Date: May 19, 2011

(54) SOAP DISPENSER

(75) Inventors: Frank Yang, Rancho Palos Verdes, CA (US); Joseph Sandor, Santa Ana Heights, CA (US)

(73) Assignee: SIMPLEHUMAN, LLC, Torrance, CA (US)

(21) Appl. No.: 12/949,672

(22) Filed: Nov. 18, 2010

Related U.S. Application Data
(60) Provisional application No. 61/262,508, filed on Nov. 18, 2009.

(51) Int. Cl. B67D 7/08; B67D 7/58; B67D 7/74

(52) U.S. Cl. 222/52; 222/190; 222/639; 222/333; 222/571

(57) ABSTRACT

A soap dispenser can be configured to dispense an amount of foam soap, for example, upon detecting the presence of an object. The dispenser can also include a gear-type pump that mixes air with liquid soap to create foamed pump. The dispenser can also include two pumps, one pump to feed liquid pump to a second pump that is configured to mix air with liquid soap to thereby create foamed soap. The dispenser can include a reservoir in its discharge passage to reduce unwanted dripping of foam soap or the liquid remains of foam soap, from a foam soap outlet.

### CROSS REFERENCE TO RELATED APPLICATION

This application claims the benefit of U.S. provisional application No. 61/262,508 titled “SOAP DISPENSER” filed on 18 Nov. 2009, the content of which is incorporated by reference herein in its entirety.

### BACKGROUND OF THE INVENTION

1. Field of the Inventions

The present inventions relate to dispensing devices including soap dispensers.

2. Description of the Related Art

Users of modern public washroom facilities increasingly desire that each of the fixtures in the washroom operate automatically without being touched by the user's hand. This is important in view of increased user awareness of the degree to which germs and bacteria may be transmitted from one person to another in a public washroom environment. Today, it is not uncommon to find public washrooms with automatic, hands-free operated toilet and urinal units, hand washing faucets, soap dispensers, hand dryers, and door opening mechanisms. This automation allows the user to avoid touching any of the fixtures in the facility, and therefore lessens the opportunity for the transmission of disease-carrying germs or bacteria resulting from manual contact with the fixtures in the washroom.

### SUMMARY

An aspect of at least one of the embodiments disclosed herein includes the realization that a gear pump can be used to mix air and liquid soap to thereby create foamed soap. Thus, in accordance with an embodiment, a foamed soap dispenser can comprise a reservoir configured to store liquid soap, and a gear pump comprising pump chamber having a gear pump inlet and a gear pump outlet, a liquid soap inlet connected to the reservoir so as to guide liquid soap from the reservoir to the gear pump inlet of the pump chamber, an air inlet configured to allow air to flow into the gear pump inlet of the pump chamber, and a pair of pump gears meshed with each other and disposed in the pump chamber. A motor can be configured to drive the gear pump such that liquid soap and air are mixed in the pump chamber by the meshed pump gears when the gear pump is driven by the motor.

Another aspect of at least one of the embodiments disclosed herein includes the realization that the dynamics of liquid soap can cause certain difficulties with regard to foaming soap pumps. For example, if a soap pump having a liquid soap inlet and an air inlet designed to foam soap is connected to and disposed below a level of liquid in a liquid soap reservoir, liquid soap can flow into and swamp the pump. When such a pump is swamped with liquid soap, the pump requires additional time to clear the air inlet passage before it can effectively mix air and liquid to crate foam. Additionally, when the pump is driven in a swamped state, the pump initially ejects liquid soap and then partially foamed soap before it can eject fully foamed soap. As such, the pump does not issue foamed soap in a uniform manner.

Thus, in accordance with another embodiment, a foamed soap dispenser can comprise a reservoir configured to store liquid soap and a first pump comprising a first pump outlet, a first liquid soap inlet, and a first air inlet configured to allow air to flow into the first pump, the first air inlet and the first liquid soap inlet being disposed above a maximum fill elevation for liquid soap in the reservoir. A motor can be configured to drive the first pump. A second pump can have a second liquid soap pump inlet disposed below the maximum fill elevation, and a second pump outlet in fluidic communication with the first liquid soap inlet of the first pump. As such, liquid soap entering the first pump through the first liquid soap inlet is mixed with air entering the first pump from the first air inlet into foamed soap when the first pump is driven by the motor.

### BRIEF DESCRIPTION OF THE DRAWINGS

Features, aspects and advantages of the inventions disclosed herein are described below with reference to the drawings of embodiments, which are intended to illustrate and not to limit the inventions. The drawings comprise the following figures:

FIG. 1 is a schematic diagram illustrating an automatic foam soap dispenser in accordance with an embodiment;

FIG. 2 is a front, top, and left side perspective view of a modification of the automatic foam soap dispenser of FIG. 1;

FIG. 3 is a left side elevational and partial schematic view of the foam soap dispenser of FIG. 2;

FIG. 4 is a top plan view of the foam soap dispenser of FIG. 2;

FIG. 5 is a rear elevational view of the foam soap dispenser of FIG. 2;

FIG. 6 is a front, bottom, and right side exploded perspective view of the foam soap dispenser in FIG. 2, showing a pump and motor cavity cover member, a battery compartment cover member, and a gasket separated from the main housing thereof;

FIG. 7 is a sectional view of a soap reservoir of the foam soap dispenser of FIG. 2, illustrating a portion of the reservoir, a pump body, a pump cover, and a portion of a drive sheave for the pump illustrated in sections;

FIG. 8 is another sectional view of the pump, cover, and pulley illustrated in FIG. 7;

FIG. 9 is a front, left, and bottom perspective view of the reservoir of the foam soap dispenser of FIG. 2 and having the pump member exploded and separated from the bottom;

FIG. 10 is a top view of an interior of an embodiment of a gear pump housing;

FIG. 11 is an enlarged side sectional view of an automatic foam soap dispenser in accordance with an alternate embodiment in which the air conduit penetrates the posterior of the pump;

FIG. 12 is a side sectional view of an automatic foam soap dispenser in accordance with another embodiment in which the air conduit is integrally formed in the dispenser;

FIG. 13 is a side sectional view of an embodiment of a discharge nozzle;

FIG. 14 is a schematic diagram illustrating an automatic foam soap dispenser in accordance with another embodiment;

FIG. 15 is a front, top, and left side perspective view of a modification of the automatic foam soap dispenser of FIG. 15;

FIG. 16 is a front view of the foam soap dispenser of FIG. 15;

FIG. 17 is a cross-sectional view of the foam soap dispenser of FIG. 15 along the line A-A;

FIG. 18 is a cross-sectional view of the foam soap dispenser of FIG. 15 along the line B-B;

FIG. 19 is a cross-sectional view of the foam soap dispenser of FIG. 15 along the line C-C, which is at about a 45° angle from the view of FIG. 16;

FIG. 20 is a front, right, and top perspective view of the foam soap dispenser of FIG. 15 having the casing and pump members exploded;

FIG. 21 is a front, left, and top perspective view of the mount, pump, and sheath of the foam soap dispenser of FIG. 15;

FIG. 22 is a front, right, and top perspective view of the mount and pump of the foam soap dispenser of FIG. 15;

FIG. 23 is a front, right, and top perspective view of the pump of the foam soap dispenser of FIG. 15;

FIG. 24 is a top view of the pump of the foam soap dispenser of FIG. 15;

FIG. 25 is a back, left, and top perspective view of the mount and pump of the foam soap dispenser of FIG. 15 having the pump member exploded;

FIG. 26 is a schematic flow chart of a control routine that can be used with the automatic foam soap dispensers of FIGS. 1-25; and

FIG. 27 is a flow chart of another control routine that can be used with the foam soap dispensers of FIGS. 1-25.

### DETAILED DESCRIPTION

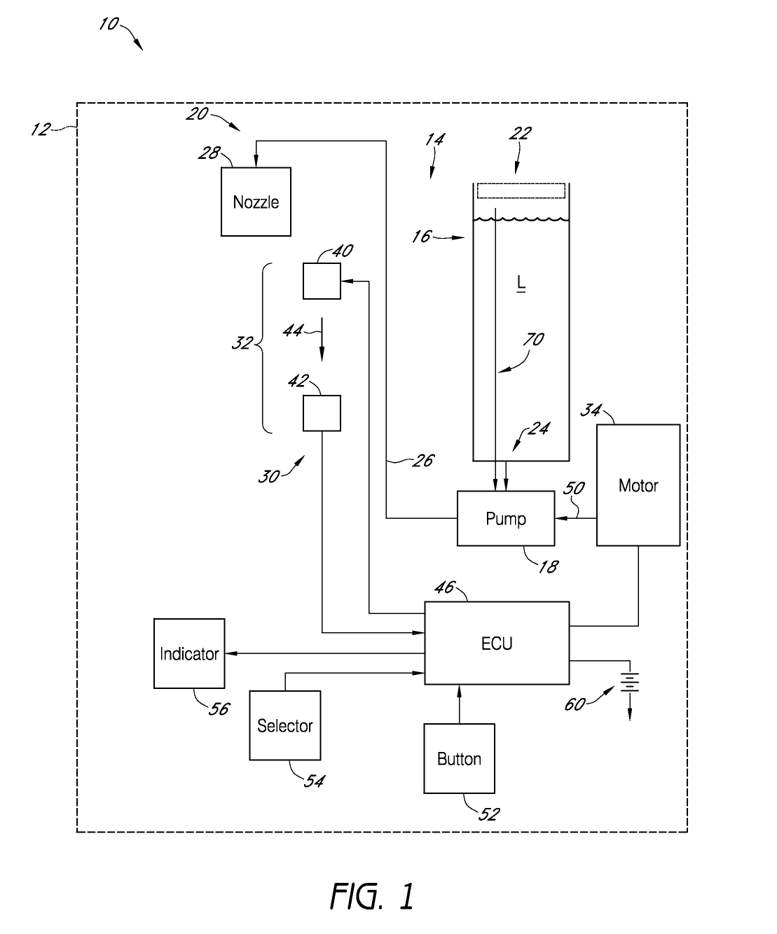

FIG. 1 schematically illustrates an embodiment of an electric liquid soap dispenser 10 that can include various features and embodiments of the inventions disclosed herein. The present inventions are disclosed in the context of a foam soap dispenser 10 because they have particular utility in this context. However, many of the inventions disclosed herein can be used in many other diverse contexts and environments of use. For example, many or all of the inventions disclosed herein can be used in other types of pumps, dispensers, battery-powered devices, or even any other electric devices. Those of ordinary skill in the art will recognize, from the description set forth below, many of the other environments of use in which the present inventions can be used, although all of those environments are not described herein.

With continued reference to FIG. 1, the soap dispenser 10 includes a housing 12. The housing 12 can take any shape.

The dispenser 10 can include a liquid handling system 14. The liquid handling system 14 can include a reservoir 16, a pump 18, an air inlet conduit 70, and a discharge assembly 20.

The reservoir 16 can be any type of container. In the illustrated embodiment, the reservoir 16 is configured to contain a volume of liquid soap, such as liquid soap for hand washing, and lotion. In some embodiments, the reservoir 16 can include a lid 22 configured to form a seal at the top of the reservoir 16 for maintaining the liquid soap L within the reservoir 16. Additionally, in some embodiments, the lid 22 can include an air vent (not shown), so as to allow air to enter the reservoir 16 as the level of liquid soap L falls within the reservoir 16.

The reservoir 16 can also include an outlet 24 disposed at a lower end of the reservoir 16. The reservoir 16 can be connected to the pump 18 through the opening 24.

The air inlet conduit 70 can be any type or diameter of conduit, so as to allow air to enter the pump 18. In some embodiments, the air inlet conduit 70 is disposed outside the reservoir 16. In other embodiments, the air inlet conduit 70 is positioned in the reservoir 16. The air inlet conduit 70 can be connected to the inlet of the pump 18 through the reservoir outlet 24.

In some embodiments, the pump 18 can be disposed directly below the outlet 24 of the reservoir 16. As such, the pump 18, depending on the type of pump used, can be automatically primed due to the force of gravity drawing liquid soap L into the pump 18 through the opening 24.

The pump 18 can be connected to the discharge system 20 with a conduit 26. Any type or diameter of conduit can be used.

The discharge assembly 20 can include a discharge nozzle 28. Any type of discharge nozzle can be used. For example, the size of the discharge nozzle 28 can be determined to provide the appropriate flow rate and/or resistance against flow of foam soap from the pump 18.

In some embodiments, the nozzle 28 can be disposed at a location spaced from the lower portion of the housing 12 so as to make it more convenient for a user to place their hand or other body part under the nozzle 28. In some embodiments, the nozzle 28 can be configured to reduce undesired dripping of soap (liquid or foamed) from the nozzle 28 after a dispensing cycle ends. For example, in some embodiments, the nozzle 28 can be disposed on a vertical portion of the housing 12, so that the force of gravity encourages the foam soap to shear from the nozzle 28 after dispensation. However, other configurations can also be used.

The dispenser 10 can also include a pump actuation system 30. In some embodiments, the pump actuation 30 system can include a sensor device 32 and an actuator 34.

In some embodiments, the sensor device 32 can include a “trip light” or “interrupt” type sensor. For example, as illustrated in FIG. 1, the sensor 32 can include a light emitting portion 40 and a light receiving portion 42. As such, a beam of light 44 can be emitted from the light emitting portion 40 and received by the light receiving portion 42.

The sensor 32 can be configured to emit a trigger signal when the light beam 44 is blocked. For example, if the sensor 32 is activated, and the light emitting portion 40 is activated, but the light receiving portion 42 does not receive the light emitted from the light emitting portion 40, then the sensor 32 can emit a trigger signal. This trigger signal can be used for controlling operation of the motor or actuator 34, described in greater detail below. This type of sensor can provide further advantages.

For example, because the sensor 32 is an interrupt-type sensor, it is only triggered when a body is disposed in the path of the beam of light 44. Thus, the sensor 32 is not triggered by movement of a body in the vicinity of the beam 44. Rather, the sensor 32 is triggered only if the light beam 44 is interrupted. To provide further prevention of unintentional triggering of the sensor 32, the sensor 32, including the light emitting portion 40 and the light receiving portion 42, can be recessed in the housing 12.

In addition to these advantages, other advantages can also be provided. For example, the sensor 32 only requires enough power to generate a low power beam of light 44, which may or may not be visible to the human eye, and to power the light receiving portion 42. These types of sensors require far less power than infrared or motion-type sensors. Additionally, the sensor 32 can be operated in a pulsating mode. For example, the light emitting portion 40 can be powered on and off in a cycle such as, for example, but without limitation, for short bursts lasting for any desired period of time (e.g., 0.01 second, 0.1 second, 1 second) at any desired frequency (e.g., once per half second, once per second, once per ten seconds). These different time characteristics can be referred to as an activation period or frequency, which corresponds to the periodic activation of the sensor 32. Thus, an activation frequency of four times per second would be equivalent to an activation period of once per quarter second.

The other aspect of this characteristic can be referred to as an activation duration. Thus, if the sensor 32 is activated for 50 microseconds, 50 microseconds is the activation duration time period. As such, this type of cycling can greatly reduce the power demand for powering the sensor 32. In operation, such cycling does not produce unacceptable results because as long as the user maintains their body parts or other appendage or device in the path of the light beam 44 long enough for a detection signal to be generated, the sensor 32 will be triggered.

In some embodiments, the sensor device 32 can include an infrared type sensor. For example, the sensor 32 can include a light emitting portion and a light receiving portion. The light emitting and light receiving portions can be separate, or in some embodiments they can be part of the same device. Thus, in use, a beam of infrared light can be emitted from the light emitting portion and reflected back and received by the light receiving portion. This reflection occurs as a result of the user placing his or her hand or some object in front of the infrared sensor and reflecting back the emitted infrared light for a predetermined period of time at a predetermined frequency.

The sensor 32 can be configured to emit a trigger signal when the infrared light beam is reflected back to the light receiving portion. For example, if the sensor 32 is activated and the light receiving portion receives the reflected infrared light emitted from the light emitting portion, then the sensor 32 can emit a trigger signal. This trigger signal can be used for controlling operation of the motor or actuator 34.

The sensor 32 can be operated in a pulsating mode. For example, the light emitting portion can be powered on and off in a cycle such as, for example, but without limitation, for short bursts lasting for any desired period of time (e.g., 0.01 second, 0.1 second, 1 second) at any desired frequency (e.g., once per half second, once per second, once per ten seconds). These different time characteristics can be referred to as an activation period or frequency, which corresponds to the periodic activation of the sensor 32. Thus, an activation frequency of four times per second would be equivalent to an activation period of once per quarter second.

The sensor 32 can be connected to a circuit board, an integrated circuit, or other device for triggering the actuator 34. In the illustrated embodiment, the sensor 32 is connected to an electronic control unit 46 (“ECU”). However, other arrangements can also be used.

The ECU 46 can include one or a plurality of circuit boards providing a hard wired feedback control circuits, a processor and memory devices for storing and performing control routines, or any other type of controller. In an exemplary but non-limiting embodiment, the ECU 46 can include an H-bridge transistor/MOSFET hardware configuration which allows for bidirectional drive of an electric motor, and a microcontroller such as Model No. PIC16F685 commercially available from the Microchip Technology Inc., and/or other devices.

The actuator 34 can be any type of actuator. For example, but without limitation, the actuator 34 can be an AC or DC electric motor, stepper motor, server motor, solenoid, stepper solenoid, or any other type of actuator. Optionally, the actuator 34 can be connected to the pump 18 with a transmitter device 50. For example, the transmitter device 50 can include any type of gear train or any type of flexible transmitter assembly.

With continued reference to FIG. 1, the dispenser 10 can also include a user input device or a button 52. The user input device 52 can be any type of device allowing a user to input a command into the ECU 46. In a non-limiting embodiment, the input device 52 is in the form of a button configured to allow a user to depress the button so as to transmit a command to the ECU 46. For example, the ECU 46 can be configured to actuate the actuator 34 to drive the pump 18 any time the input device 52 is actuated by a user. The ECU 46 can also be configured to provide other functions upon the activation of the input device 52, described in greater detail below.

The dispenser 10 can also include a selector device 54. The selector device or input device 54 can be in any type of configuration allowing the user to input a proportional command to the ECU 46. For example, the selector 54 can have at least two positions, such as a first position and a second position. The position of the input device 54 can be used to control an aspect of the operation of the dispenser 10.

For example, but without limitation, the input device 54 can be used as a means for allowing a user to select different amounts of foam soap F (not referenced in FIG. 1) to be dispensed from the discharge nozzle 28 during each dispensation cycle. As such, when the input device 54 is in a first position, the ECU 46 can operate the actuator 34 to drive the pump 18 to dispense a predetermined amount of foam soap F from the discharge nozzle 28, each time the sensor 32 is triggered. When the input device 54 is in the second position, the ECU 46 can actuate the actuator 34 to dispense a larger amount of foam soap F from the discharge nozzle 28.

Optionally, in some embodiments, the input device 54 can provide a more continuous range of output values to the ECU 46, or a larger number of steps, corresponding to different volumes of foam soap F to be dispensed each dispensation cycle performed by the ECU 46. Although the positions of the input device 54 may correspond to different volumes of foam soap F, the ECU 46 can correlate the different positions of the input device 54 to different duty cycle characteristics or durations of operation of the actuator 34, thereby at times discharging differing or slightly differing volumes of foam soap F from the nozzle 28.

The dispenser 10 can also include an indicator device 56 configured to issue a visual, aural, or other type of indication to a user of the dispenser 10. For example, in some embodiments, the indicator 56 can include a light and/or an audible tone perceptible to the operator of the dispenser 10. In some embodiments, the ECU 46 can be configured to actuate the indicator 56 to emit a light and/or a tone after a predetermined time period has elapsed after the actuator 34 has been driven to dispense a predetermined amount of foam soap F from the nozzle 28. As such, the indicator provides a reminder to a user of the dispenser 10 to continue to wash their hands until the indicator has been activated. As such, this predetermined time period can be about 20 seconds, although other amounts of time can also be used. Optionally, the indicator 56 can be used for other purposes as well.

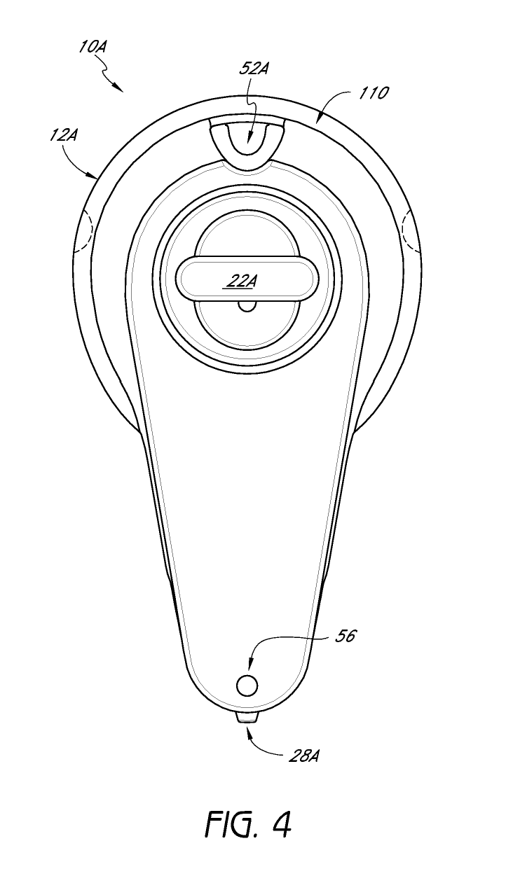

Further advantages can be achieved where the indicator 56 is activated for a predetermined time after the pump 18 has completed a pumping cycle (described in greater detail below with reference to FIG. 4. For example, but without limitation, the ECU 46 can be configured to activate the indicator 56 for 20 seconds after the pump 18 has been operated to discharge an amount of soap from the nozzle 28. As such, the indicator 56 will be activated at the appropriate time for advising the user as to how long they should wash their hands.

In some embodiments, the indicator 56 can be a Light Emitting Diode (LED) type light, and can be powered by the ECU 46 to blink throughout the predetermined time period. Thus, a user can use the length of time during which the indicator 56 blinks as an indication as to how long the user should continue to wash their hands with the soap disposed from the nozzle 28. Other types of indicators and predetermined time periods can also be used.

The dispenser 10 can also include a power supply 60. The power supply 60 can be a battery or can include electronics for accepting AC or DC power.

In operation, the ECU 46 can activate the sensor 32, continuously or periodically, to detect the presence of an object between the light emitting portion 40 and the light receiving portion 42 thereof. In embodiments in which the sensor device 32 includes an “interrupt” type sensor, when an object blocks the light beam 44, the ECU 46 determines that a dispensing cycle should begin. In embodiments in which the sensor device 32 includes an infrared type sensor, when an object reflects a sufficient amount of the infrared light back, the ECU 46 determines that a dispensing cycle should begin. The ECU 46 can then actuate the actuator 34 to drive the pump 18 to thereby dispense foam soap from the nozzle 28.

As noted above, in some embodiments, the ECU 46 can vary the amount of foam soap F dispensed from the nozzle 28 for each dispensation cycle, depending on a position of the selector 54. Thus, for example, the dispenser 10 can be configured to discharge a first volume of foam soap F from the nozzle 28 when the selector is in a first position, and to discharge a second different amount of foam soap F when the selector 54 is in a second position.

Optionally, as noted above, the indicator 56 can be activated, by the ECU 46, after a predetermined amount of time has elapsed after each dispensation cycle. Further, the ECU 46 can be configured to cancel or prevent the indicator 56 from being activated if the button 52 has been actuated in accordance with a predetermined pattern. For example, but without limitation, the ECU 46 can be configured to cancel the activation of the indicator 56 if the button 52 has been pressed twice quickly. However, any pattern of operation of the button 52 can also be used as the command for canceling the indicator 56. Additionally, the dispenser 10 can include other input devices for allowing a user to cancel the indicator 56.

Optionally, the ECU 46 can be configured to continuously operate the actuator 34 or to activate the actuator 34 for a maximum predetermined time when the button 52 is depressed. As such, this allows an operator of the dispenser 10 to manually operate the dispenser to continuously discharge or discharge larger amounts of foam soap F when desired. For example, if a user of the dispenser 10 wishes to fill a sink full of soapy water for washing dishes, the user can simply push the button 52 and dispense a larger amount of soap that would normally be used for washing one's hands. However, other configurations can also be used.

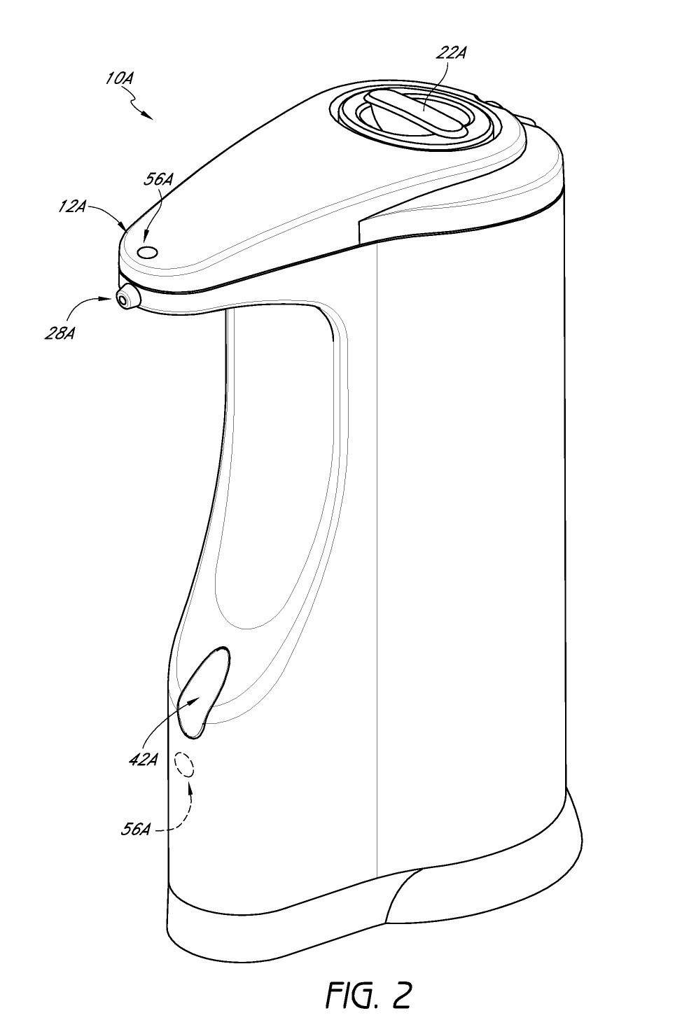

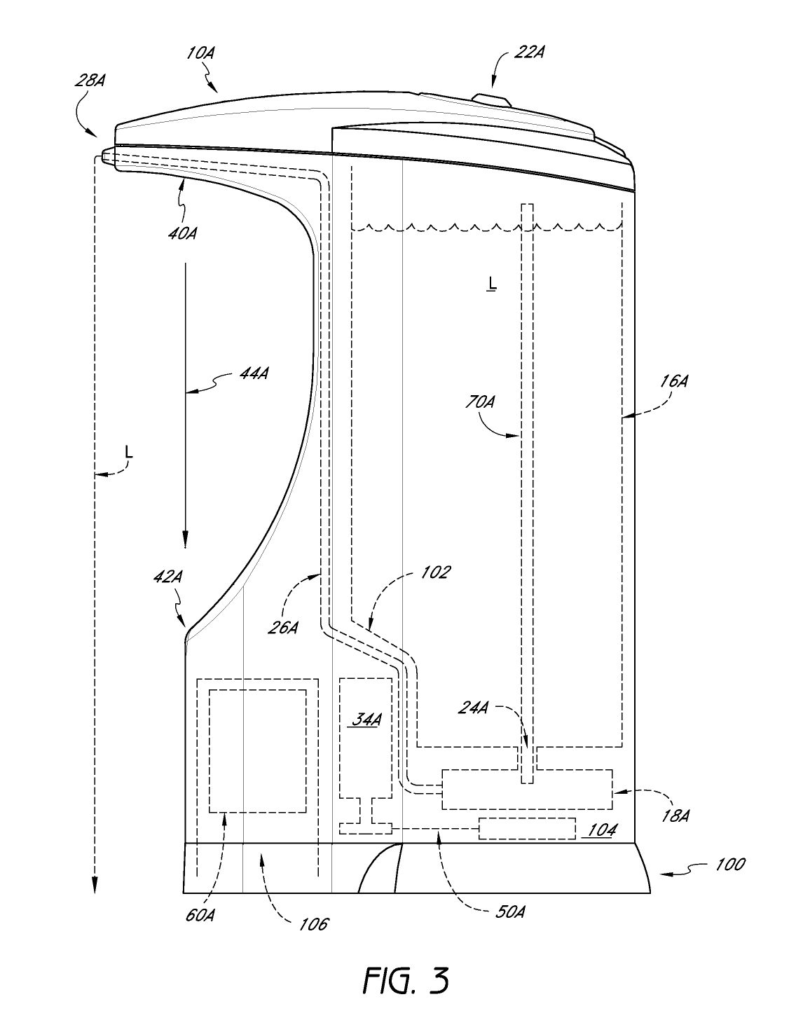

FIGS. 2 and 3 illustrate a modification of the dispenser 10, identified generally by the reference numeral 10A. Some of the components of the dispenser 10A can be the same, similar, or identical to the corresponding components of the dispenser 10 illustrated in FIG. 1. These corresponding components are identified with the same reference numeral, except that an “A” has been added thereto.

As shown in FIGS. 2 and 3, the lower end 100 of the dispenser 10A is designed to support the housing 12A on a generally flat surface, such as those normally found on a countertop in a bathroom or a kitchen. In some embodiments, the nozzle 28A can be disposed in a manner such that the nozzle 28A extends outwardly from the periphery defined by the lower portion 100. As such, if a user misses soap dispensed from the nozzle 28A, and the foam soap F falls, it will not strike on any portion of the housing 12A. This helps prevent the dispenser 10A from becoming soiled from dripping soap F.

In some embodiments the indicator 56A, which can be a visual indicator such as an LED light, can be positioned on the outer housing 12A, above the nozzle 28A. As such, the indicator 56A can be easily seen by an operator standing over the dispenser 10A. Additionally, in some embodiments, the visual type indicator 56A can be disposed on a lower portion of the housing 12A (illustrated in phantom line). However, the indicator 56A can also be positioned in other locations.

As shown in FIG. 3, the reservoir 16A can be disposed within the housing 12A. The pump 18A can be disposed beneath the reservoir 16A, such that the outlet 24A of the reservoir 16A feeds into the pump 18A. As such, as noted above, this helps the pump 18A to achieve a self-priming state due to the force of gravity drawing liquid soap L through the outlet 24A into the pump 18A.

The air inlet conduit 70A can be disposed within the reservoir 16A. One end of the conduit 70A can be positioned above the fill level of the reservoir 16A and be open to the atmosphere. Another end of the air inlet conduit 70A may connect to the inlet of the pump 18A by routing through the outlet 24A. As such, the air can be drawn from near the top of the reservoir 16A, travel through the air inlet conduit 70A, and enter the inlet of the pump 18A.

In some embodiments, the reservoir 16A can include a recess 102. As such, the actuator 34A can be disposed somewhat nested with the reservoir 16A. This provides for a more compact arrangement and allows the reservoir 16A to be as large as possible.

In some embodiments, the housing 12A can define a pump and motor chamber 104 and a battery chamber 106. The pump 18A and actuator 34A can be disposed within the pump and motor chamber 104 and the power supply 60A can be disposed in the battery chamber 106. In some embodiments, the chambers 104, 106 can be defined by inner walls of the housing 12A and/or additional walls (not shown). However, other configurations can also be used.

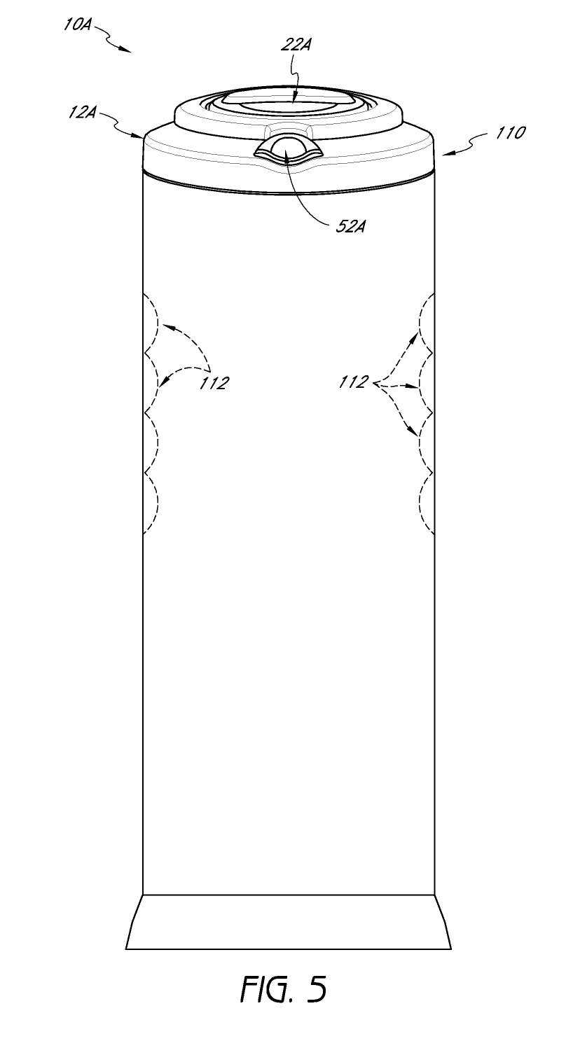

With reference to FIGS. 4 and 5, the button 52A can be disposed anywhere on the housing 12A. In some embodiments, as shown in FIGS. 4 and 5, the button 52A can be disposed on an upper portion 110 of the housing 12A. As such, the button 52A is positioned conveniently for actuation by a user of the dispenser 10A.

Further, in some embodiments, the button 52A can be disposed proximate to an outer periphery of the housing 12A, on the upper portion 110, and approximately centered along a rear surface of the housing 12A. As such, this provides a location in which a user can easily grasp the outer surface of the housing 12A with three fingers and their thumb, and actuate the button 52A with their index finger.

Optionally, the housing 12A can include surface textures 112 configured to allow a user to obtain enhanced grip on the housing 12A when attempting to lift the dispenser 10A and depress the button 52A. Such surface textures 112 can have any configuration. In some embodiments, the surface textures 112 are in the form of finger shaped recesses. However, other configurations can also be used.

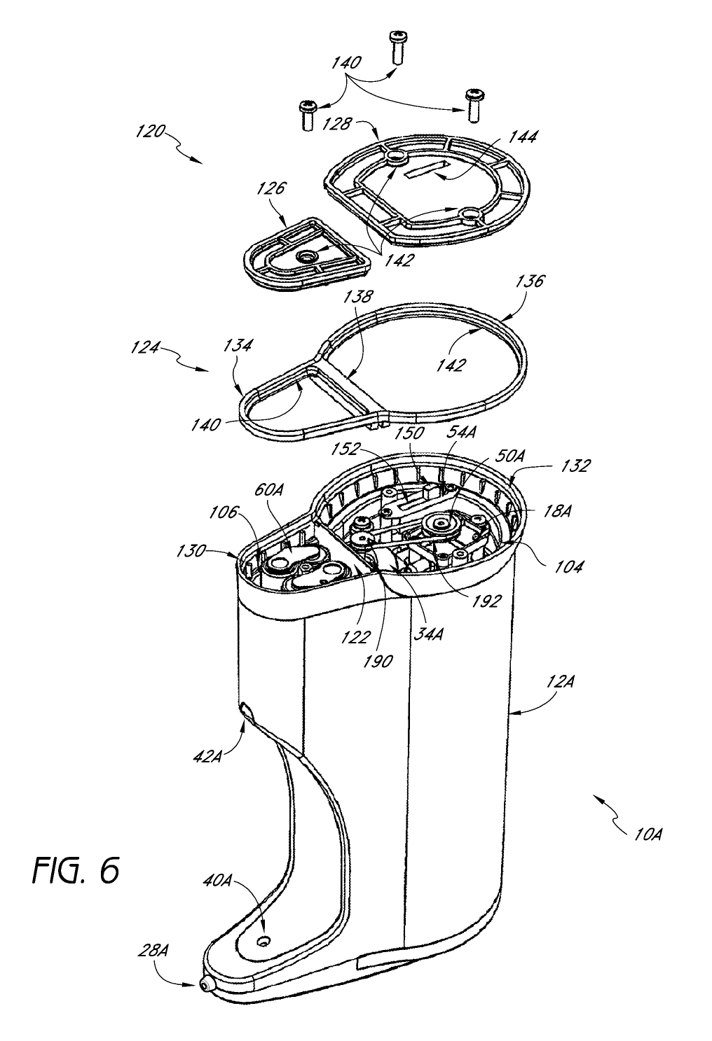

With reference to FIG. 6, as noted above, the dispensers 10, 10A can include a support member arrangement 120 that can achieve the dual functions of providing a support leg or foot for the associated dispenser and provide a sealing function for internal cavities disposed within the associated dispenser.

As noted above, the dispenser 10A can include internal cavities 106, 104 for containing the power supply 60A and the pump 18A and actuator 34A, respectively. Of course, as noted above, other interior compartments can also be used.

As shown in FIG. 6, an interior wall 122 is disposed between the compartments 104, 106. However, this is merely optional.

The sealing arrangement 120 can include a gasket member 124 and lid members 126, 128. The gasket 124 can be configured to extend around an opening 130 of the compartment 106 and an opening 132 of the compartment 104. Thus, in some embodiments, the gasket member 124 can include a battery compartment portion 134 and a pump and motor compartment portion 136.

The battery compartment portion 134 is configured to extend around an interior periphery of the opening 130. However, this is just one configuration that can be used. The portion 134 can be configured to straddle a lower-most edge of the opening 130, or to extend around an outer periphery of the opening 130.

Similarly, the pump and motor compartment portion 136 is configured to extend along an inner periphery of the opening 132. In some embodiments, the portions 134, 136 are configured to rest against a shelf defined along the inner peripheries of the openings 130, 132. However, other configurations can also be used.

A center dividing portion 138 of the gasket 124 can be configured to form a seal along the lower-most edge of the wall 122. However, other configurations can also be used.

The lids 126, 128 are configured to rest against inner walls 140, 142 defined by the portions 134, 136, respectively. As such, the lid members 126, 128 form seals with the inner peripheral walls 140, 142, respectively. The seals help protect the components disposed within the compartments 106, 104.

Optionally, fasteners 154 can be used to secure the lid members 126, 128 to the housing 12A. For example, the lid members 126, 128 can include apertures 142 through which the fasteners 154 can extend. The fasteners 154 can engage mounting portions disposed within the housing 12A. As such, the lid members 126, 128 can be secured to the housing 12A and form a seal with the gasket member 124.

Optionally, at least one of the lid members can include an additional aperture 144 configured to allow access to a device disposed in one of the compartments 104, 106. In the illustrated embodiment, the aperture 144 is in the form of a slot. However, any type of aperture can be used.

The slot 144 can be configured to allow a portion of the selector 54A to extend therethrough. For example, the selector 54A is in the configuration of a slider member 150 slidably disposed in a housing 152. As such, for example, the selector 54A can be in the configuration of a rheostat or other type of input device that allows for a proportional signal.

For example, as noted above, the housing 152 can be configured to allow the member 150 to be slid between at least two positions. For example, the two positions can be a first position corresponding to a first amount of foam soap F to be discharged by the nozzle 28A and a second position corresponding to a second larger volume of foam soap F to be discharged by the nozzle 28A. Optionally, the housing 152 can be configured to allow the slider member 150 to be slid between a plurality of steps or continuously along a defined path to provide continuously proportional signals or a plurality of steps.

In some embodiments, with the gasket member 124 and lid member 128 in place, the slider member 150 can be configured to extend through the slot 144 such that a user can conveniently move the slider member 150 with the lid 128 in place. In other embodiments, the slider member 150 can be smaller such that an object such as a pen can be inserted into the slot 144 to move the slider member 150. Other configurations can also be used.

With continued reference to FIG. 6, when the lids 126, 128 and gasket member 124 are in place, the compartments 104, 106 are substantially sealed and thus protected from the ingress of water and/or other substances. Additionally, as noted above, the gasket member 124 can be configured to extend downwardly from the housing 12A such that the gasket member 124 defines the lower-most portion of the device 10A. As such, the gasket member provides a foot or a leg for supporting the device 10A.

Further, in a configuration in which the lower-most edge of the gasket member 124 is substantially continuous and smooth, the gasket member 124 can provide a suction cup-like effect when it is placed and pressed onto a smooth surface. For example, where the gasket member 124 is made from a soft or resilient material, by pressing the device 10A downwardly when it is resting on a smooth surface, air can be ejected from the space between the lid members 126, 128 and the surface upon which the device 10A is resting. When the device 10A is released, the slight movement of the device 10A upwardly can cause a suction within that space, thereby creating a suction cup-like effect. This effect provides a further advantage in helping to anchor the device 10A in place on a counter, which can become wet and/or slippery during this period.

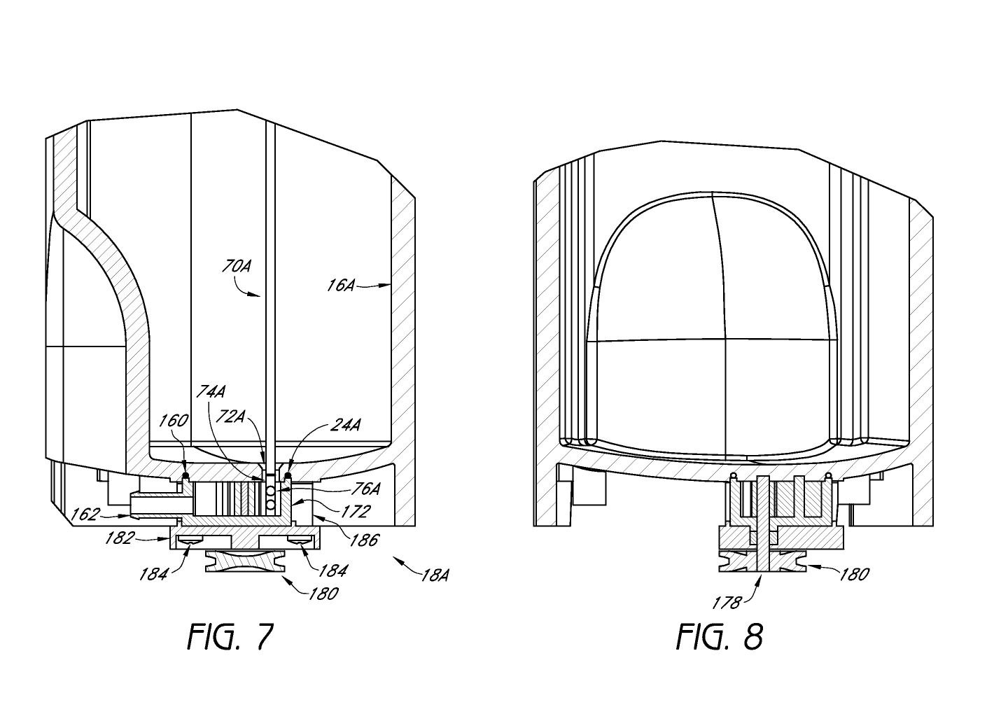

With reference to FIGS. 7-9, the pump 18A can be configured to be a reversible pump. For example, in the illustrated embodiment, the pump 18A is a gear-type pump. This type of a pump can be operated in forward or reverse modes. Additionally, this type of pump provides a compact arrangement and can provide a 90 degree turn which provides a particularly compact arrangement in the device 10A. For example, as shown in FIG. 7, the outlet 24A of the reservoir 16A feeds directly into an inlet of the pump 18A. More particularly, in the illustrated embodiment, a lower-most surface of the reservoir 16A defines an upper wall of the pump 18A. Thus, the outlet 24A also forms the inlet to the pump 18A. A gasket 160 extends around the outlet 24A and is configured to form a seal with a body of the pump 18A.

With continued reference to FIG. 7, an air inlet conduit 70A can extend through the reservoir 16A. One end of the air inlet conduit 70A can be positioned near the top of the reservoir 16A and be open to allow air to enter. A second end of the air inlet conduit 70A can pass through the outlet 24A of the reservoir 16A and connect to an air nozzle 74A located in the inlet of the pump 18A. The air inlet nozzle 74A can have a plurality of apertures 76A to permit air to pass from the nozzle 76A to the input of the pump 18A.

The air inlet conduit 70A can be sized and shaped to allow sufficient air to pass within the interior of the conduit 70A. For example, in one embodiment, the air inlet conduit 70A has an inside diameter of about 0.75 mm. The air inlet conduit 70A can also be configured to provide a clearance 72A between the exterior of the air inlet conduit 70A and the interior of the outlet 24A to allow soap to move from the reservoir 16A into the pump 18A. As such, air may be drawn into the inlet of the pump 18A via the air inlet conduit 70A and nozzle 74A, while liquid soap L may be drawn into the inlet of the pump 18A via the clearance 72A of the outlet 24A by force of gravity.

With continued reference to FIG. 7, an outlet 162 of the pump 18A is connected to an outlet chamber of the pump 18A. Although not illustrated in FIG. 7, the outlet 162 is connected to the conduit 26, 26A so as to connect the outlet 162 to the nozzle 28A.

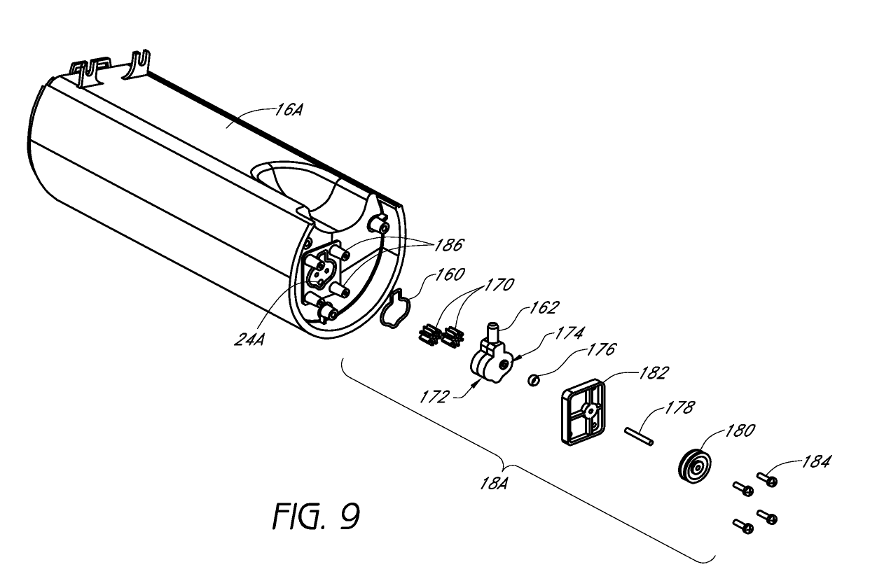

FIG. 9 illustrates an exploded view of the pump 18A. As shown in FIG. 9, the gear pump 18A includes a pair of gear members 170, a gear pump body 172, from which the outlet 162 extends.

The pump body 172 defines a generally oval and/or partially figure 8-shaped internal chamber in which the gears 170 rotate. This configuration is well known in the art, and in particular, with regard to devices known as gear pumps. Thus, a further description of the operation of the gear pump 18A is not included herein.

The housing 172 can also include a drive shaft aperture 174. A gasket 176 can be configured to form a seal against the pump housing aperture 174 and a drive shaft 178. One end of the drive shaft 178 can be connected to a driven sheave 180. The other end of the drive shaft 178 extends through the gasket 176, the aperture 174, and engages with one of the gears 170.

In some embodiments, a holding member 182 can be also used to retain the pump housing 172 against the lower face of the reservoir 16A. For example, in the illustrated embodiment, four fasteners 184 extend through corresponding apertures in the holding member 182 and into engaging portions 186 attached to the lower face of the reservoir 16A. In some embodiments, the number of fasteners 184 can be arbitrary in order to assemble the gear pump 18A.

As is well known in the art of gear pumps, the gears 170 are meshed within the pump chamber 172. Thus, when a shaft 178 is rotated to rotate one of the gears 170, the other gear 170 is also rotated. As such, the pump 18A can displace the air and liquid soap L entering the pump body 172 through the air inlet nozzle 74A and reservoir outlet 24A, respectively. The air and fluid soap L are consequently mixed, thereby producing foam soap F. The pump 18A discharges the foam F through the outlet 162.

With reference again to FIG. 6, the sheave 180 defines a part of the transmitter device 50A. The actuator 34A of FIG. 6 can also include a drive sheave 190 configured to drive the driven sheave 180 through a flexible transmitter 192. The sheaves 180, 190 can be of any ratio to produce a target pump speed.

Further improvements can also be achieved where the pump 18A is driven at a higher rpm. For example, in one embodiment, the sheave ratio of the sheaves 180 and 190 is about 1:1 and produces a pump speed of about 4,500 to 6,000 RPM. As such, the increased pump speed improves the aeration of the liquid soap L in the pump 18A and thus produces a higher quality foam soap F.

The flexible transmitter 192 can be any type of flexible transmitter, such as those well known in this art. For example, but without limitation, the flexible transmitter 192 can be a toothed belt, rubber belt, chain, etc. However, other configurations can also be used.

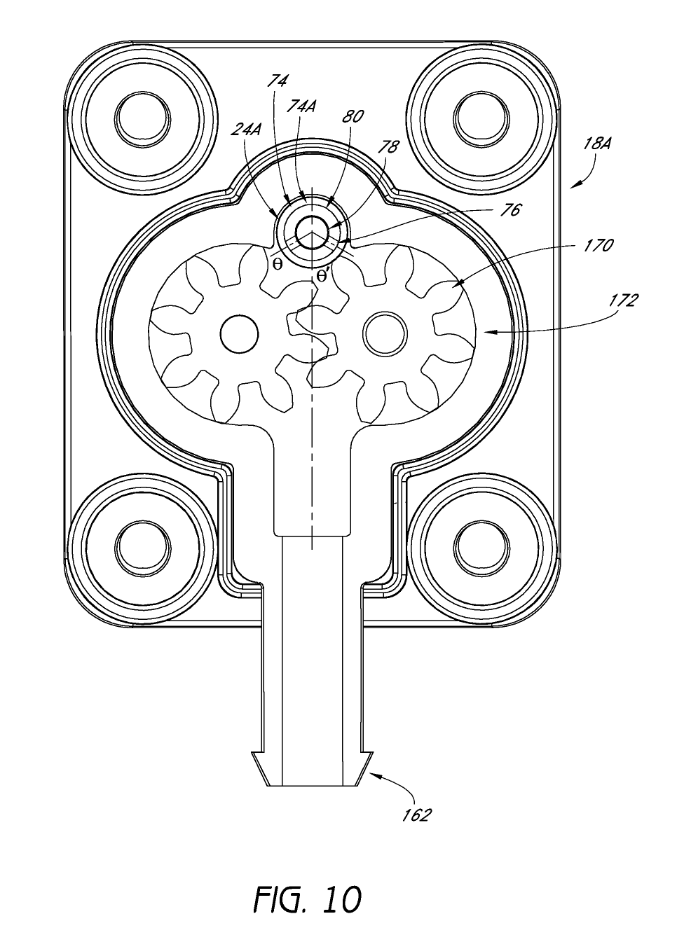

With reference to FIG. 10, the pump 18A can comprise the pair of gears 170, gear pump body 172, outlet 162, and air inlet 74. In some embodiments, the air inlet 74 can include air inlet nozzle 74A which can be in the form of a hollow structure comprising a plurality of apertures 76A, an inner surface 78A, and an outer surface 80A. In some embodiments, the air inlet nozzle 74A can be integrally formed with the pump body 172. The air inlet nozzle 74A can also be a separate component. As shown, the air inlet nozzle 74A is disposed in the inlet of the pump 18A.

The number, size, and shape of the apertures 76A can be adjusted to achieve a desired rate of air delivered to the pump 18A. For example, but without limitation, some embodiments include four circular apertures 76A each with a diameter of about 0.75 mm. However, other sizes of apertures can also be used.

The rate of air and liquid soap L permitted into the pump 18A can also be adjusted to achieve different soap-to-air ratios. In some embodiments, the soap-to-air ratio can be controlled based on the size of air inlet nozzle 74A and the apertures 76A for input of air to the pump 18A and the size of the outlet 24A for input of liquid soap L into the pump 18A. In some embodiments, the dispenser 10A can be configured with a rate of soap and air flow to produce foam from a flow with an air to soap ratio of about 4:1.

The apertures 76A can be disposed at an angle θ with respect to longitudinal axis of the gear pump body 172. In some embodiments, this angle can be about 35° to 45°. In some embodiments, this angle is about 45° to 60°. In yet further embodiments, this angle is 60° to 75°.

Some embodiments can include an aperture 76A on each side of the longitudinal axis of the gear pump body 172, the apertures having angles with respect to longitudinal axis of the gear pump body 172 of θ and θ′. In some embodiments, θ and θ′ are the same. However, configurations in which the angles θ, θ′ are different from each other can also be used.

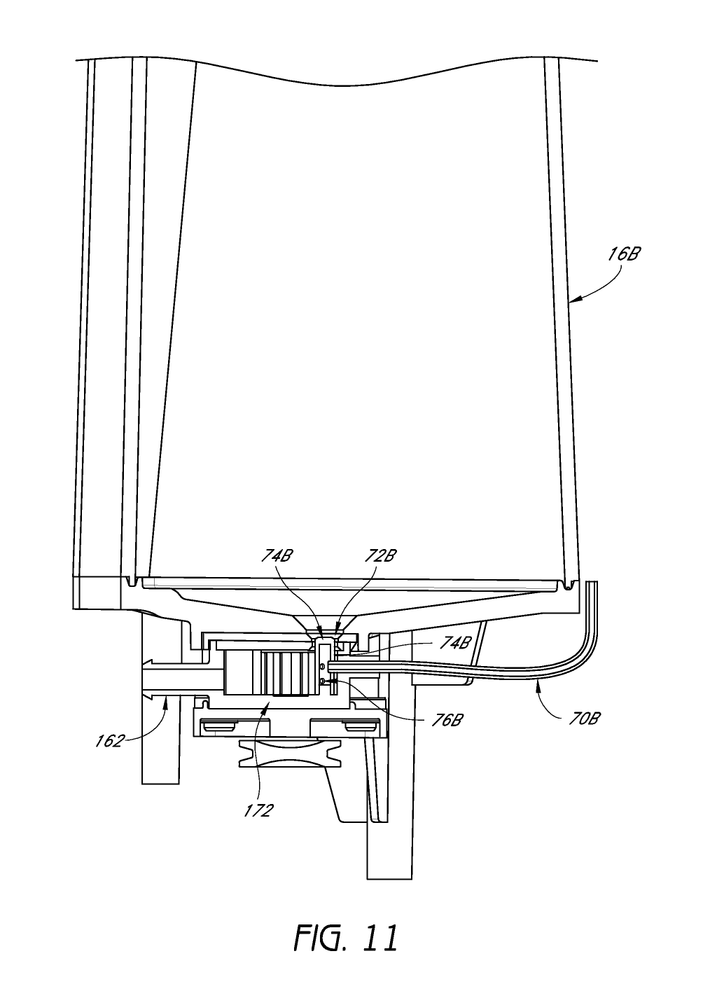

FIG. 11 illustrates embodiments of the soap dispenser 10A, in which the air inlet conduit 70B connects to the air inlet nozzle 74B by through a wall of the pump body, such as the posterior of the pump body 172.

Any arrangement of conduits, tubes, connectors, adapters, etc., can be used to form the air passage from the atmosphere to the interior of the pump body 172. As noted above, in the illustrated embodiment, the air inlet conduit 70B defines part of an air passage that extends from the atmosphere to the interior of the pump body 172.

The air inlet conduit 70B can extend outside and/or along the reservoir 16B. In some embodiments, the air inlet conduit 70B can extend above a height defined as the maximum liquid filling level of the reservoir 16B. For example, the reservoir 16B can include indicia, such as a tick mark, text, etc., indicating the recommended maximum fill level of soap in the reservoir 16B. With the upper end of the air inlet conduit 70B extending above this maximum fill level height, the head pressure of the liquid soap L in the reservoir 16B would not normally be sufficient to raise liquid soap L up to the upper end of the air inlet conduit 70B, thereby preventing liquid soap L from escaping from the upper end of the air inlet passage 70B. In some embodiment, the upper end of the air inlet conduit 70B is disposed above a top of the reservoir 16B.

Some embodiments can include a one-way valve (not shown) in the air inlet conduit 70B to prevent backflow of liquid soap L through the air inlet conduit 70B.

As noted above, one end of the air inlet conduit 70B can connect to the air inlet nozzle 74B, while the other end can be open to the atmosphere. The air inlet nozzle 74B can be dimensioned such that it extends into the reservoir outlet 24B. The relative sizes of the air inlet nozzle 74B and the outlet 24B can be chosen to achieve a desired flow of liquid soap L to into the inlet of the pump 18B. In other embodiments, the dimension of the reservoir outlet 24B can be sized achieve a desired controls the flow of liquid soap L.

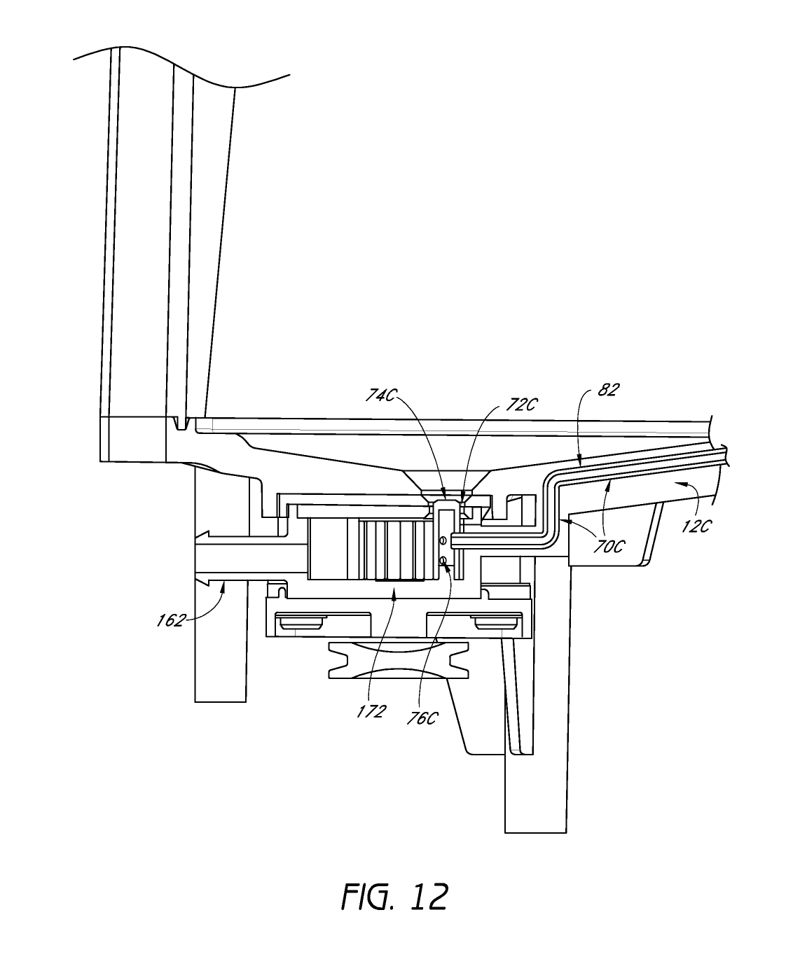

With reference to FIG. 12, an alternate embodiment of the dispenser 10 is shown in which all or a portion of the air inlet conduit 70C can be integral to the housing 12C and/or the reservoir 16C. In one embodiment, the air inlet conduit 70C can be formed within the reservoir 16C. For example, the air inlet conduit can be formed within a wall of the reservoir 16C, with one end of the conduit 70C open to the atmosphere and the other connecting to the air inlet nozzle 74C. In another embodiment, the air inlet conduit 70C is integrally formed within the housing 12C. In a further embodiment, the reservoir 16C and the housing 12C can each contain a portion of the air inlet conduit 70C.

With continued reference to FIG. 12, the air inlet conduit 70C can be formed by the interface of the reservoir 16C and the housing 12C. In one embodiment, a channel 82C is included in the exterior surface of the reservoir 16C. When the reservoir 16C is separate from the housing, the channel 82C in the reservoir 16C is open; that is, the periphery of the channel 82C is not closed. However, when the reservoir 16C is mated with the housing 12C, the reservoir 16C and housing 12C interface to close the channel 82C and thereby form a conduit.

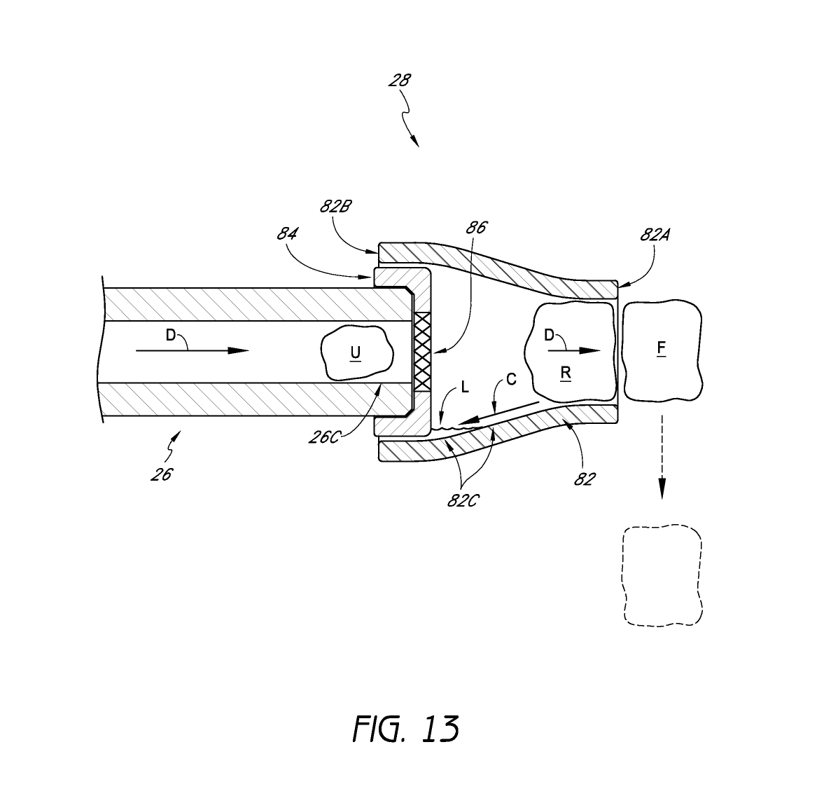

FIG. 13 illustrates a cross sectional view of an embodiment of the discharge nozzle 28. The discharge nozzle 28 can comprise a cap 84 and a screen 86. The cap 84 can be connected to the screen 86. The screen 86 can be connected to the output conduit 26.

The screen 86 can be any material, but is preferably a material that resists corrosion in the presence of water, such as plastic, rubber, stainless steel, or any other similar material.

The mesh-size of the screen 86, e.g., the size of the holes defined by the structure of the screen, can be chosen so as to provide a desired flow characteristic of foam discharged through the nozzle 28, in the downstream direction D. For example, a screen 86 can be used to provide a back pressure sufficient to briefly hold back an initial flow of foam as it is discharged from the nozzle such that the foam that is first discharged has a shape that matches the of the nozzle 28. Without such a screen or backpressure creating device, such a pump can occasionally discharge an initial amount of foam that has an outer diameter or shape that does not match the nozzle 28.

The nozzle 28 can also be configured to allow a final amount of foam discharged from the nozzle 28 to break cleanly away from foam remaining in the nozzle 28 at the end of a “dispensing cycle” (discussed in greater detail below). For example, the nozzle 28 can be configured to allow a final amount of foam F discharged from the nozzle 28 at the end of a dispensing cycle to fall downwardly, and thus generally cleanly shearing the final amount of foam F discharged from the remaining foam R in the nozzle, downstream from the screen 86.

In some embodiments, a terminal end 82A can be oriented generally vertical (e.g., when the dispenser 10 is in an upright orientation on a flat level surface). with a nozzle orientated as such, foam discharged from the nozzle 28, having about the same consistency as foam generated by the currently commercially available manual hand pumps, falls rapidly downwardly at the end of a dispensing cycle, generally cleanly shearing itself from the remaining foam. Other configurations of the nozzle 28 can also be used to achieve the above noted effect.

Additionally, the nozzle 28 can also be configured to reduce the amount of remaining foam R that flows (drips) out of the nozzle 28 after a dispensing cycle ends. Such dripping can occur when the remaining foam in known foam soap pump discharge nozzles loses its stiffness over time, then slowly drips out and often onto a counter top upon which such a pump sits. Additionally, such remaining foam can condense back into a liquid and thus become denser and more likely to flow out under gravity.

Thus, in some embodiments, the end 82A of the nozzle 28 can be oriented so as to be generally vertical or facing an upward direction. As such, the stiffness of the foam having the consistency described above, tends to remain in the nozzle, in the space between the screen 86 and the end 82A. Additionally, even as the remaining foam R loses its stiffness, the remaining foam R remains in the nozzle 28 longer as compared to nozzles shaped like nozzle 28, but facing a downwardly angle. As such, dripping is reduced with a generally vertical or upwardly facing tend surface 82A of the nozzle.

Further improvements in reducing unintended dripping can be achieved where the nozzle is formed with a wide inlet end 82B. As shown in FIG. 13, the nozzle 28 include an inlet end 82B that includes a lower inner wall 82C that is downstream from the screen 86 and sloped downwardly in the upstream direction. In the illustrated embodiment, the inner surface 82C terminates at the end 82B at a height that is lower than the terminal end of the inner surface 26C of the output conduit 26. As such, as the remaining foam R condenses back into a liquid L, it would tend to flow downwardly and in the upstream direction C, thereby further reducing the likelihood of unintended dripping out of the nozzle 28.

The screen 86 can also provide a further beneficial effect. For example, the screen 86 can help reduce a speed at which upstream foam U condenses back into a liquid. For example, one reason the bubbles inside foamed burst is the impact of dust particles (which normally float in atmospheric air) against a wall of a bubble. Thus, a screen, such as the screen 86, can help reduce the velocity of any air flow moving into the nozzle 28, in the upstream direction, as well as physically block at least some of such dust particles from impacting bubbles in the upstream foam U thereby reducing the speed at which upstream foam U condenses back into a liquid.

Further improvements can also be achieved by adjusting the mesh size of the screen 86 to limit the amount of backpressure generated by the screen 86 against reverse (“upstream”) flow of foam. For example, in some embodiments, described below, the dispenser 10A can be configured briefly suck foam backwards (in the upstream direction) at the end of a dispensing cycle, thereby reducing the volume of remaining foam R that may be present in the nozzle. Adjusting the mesh of the screen 86 to reduce reverse flow backpressure as such, allows upstream foam U and remaining foam R to be more easily drawn back into the output conduit 26 at the conclusion of dispensation, thereby reducing unintended dripping.

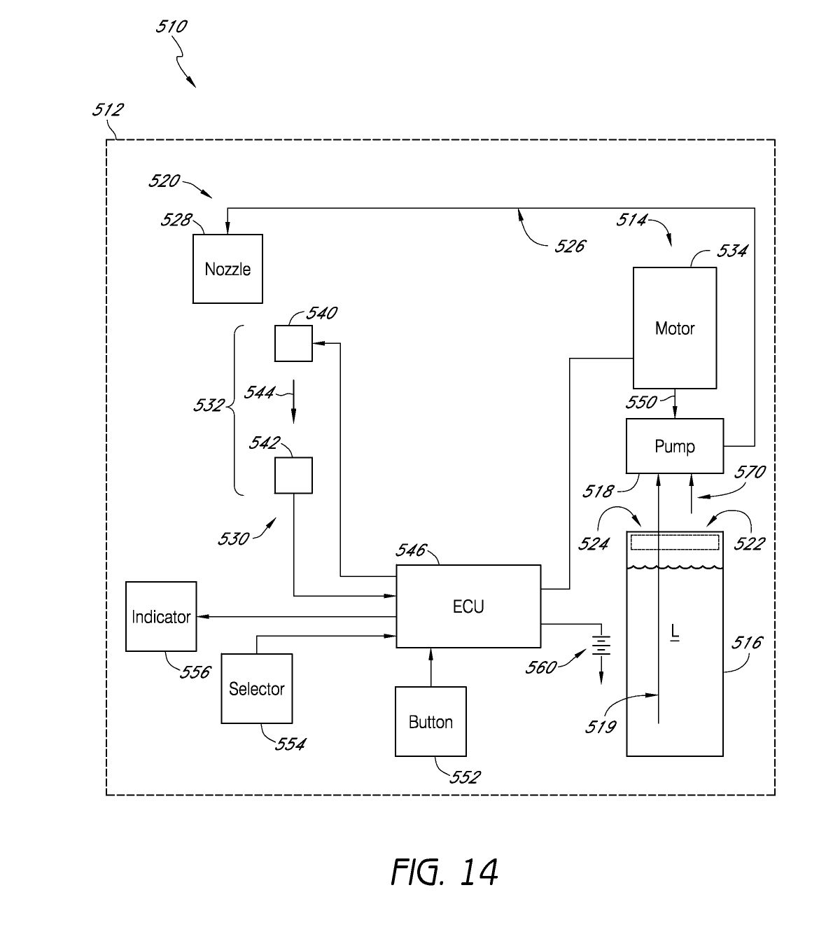

FIGS. 14-25 illustrate another embodiment of the dispenser 10, identified generally by the reference numeral 510. Some of the components of the dispenser 510 can be the same, similar, or identical to the corresponding components of the dispenser 10 illustrated in FIG. 1. Generally, corresponding components are identified with the same last two reference numerals, e.g., 10 and 510, 12 and 512, 18 and 518, etc. Any features and/or components of the disclosed embodiments can be combined or used interchangeably.

With reference to FIG. 14, the electric liquid soap dispenser 510 can include various features and embodiments of the inventions disclosed herein. The soap dispenser 510 includes a housing 512. The housing 512 can take any shape.

The dispenser 510 can include a liquid handling system 514. The liquid handling system 514 can include a reservoir 516, a pump 518, a discharge assembly 520, a soap feed mechanism 519, and air inlet conduit 570.

The reservoir 516 can be any type of container. In the illustrated embodiment, the reservoir 516 is configured to contain a volume of liquid soap, such as liquid soap for hand washing. In some embodiments, the reservoir 516 can include a lid 522 configured to form a seal at the top of the reservoir 516 for maintaining the liquid soap L within the reservoir 516. Additionally, in some embodiments, the lid 522 can include an air vent (not shown), so as to allow air to enter the reservoir 516 as the level of liquid soap L falls within the reservoir 516. The reservoir 516 can also include an outlet 524 disposed at an upper end of the reservoir 516. The reservoir 516 and the pump 518 can be in fluid communication via the outlet or opening 524.

The air inlet conduit 570 can be any type or diameter of conduit, so as to allow air to enter the pump 518. Generally, one end of the air inlet conduit 570 connects to the pump 518 and an opposite end is open to permit air to enter the pump 518 through the air inlet conduit 570. In some embodiments, the open end of the air inlet conduit 570 is disposed outside the reservoir 516. In other embodiments, the open end of the air inlet conduit 570 is positioned in the reservoir 516. In some arrangements include the air inlet conduit 570 is formed as a part of another component, e.g., in a wall of the pump 518.

In some embodiments, the pump 518 is disposed directly above the reservoir 516. The pump 518 can be connected to the discharge system 520 with a conduit 526. The discharge assembly 520 can include a discharge nozzle 528. In some arrangements, the size of the discharge nozzle 528 is configured to provide the appropriate flow rate and/or resistance against flow of foam soap from the pump 518.

The dispenser 510 can also include a pump actuation system 530. In some embodiments, the pump actuation 530 system can include a sensor device 532 and an actuator 534. In some embodiments, the sensor device 532 can include a “trip light” or “interrupt” type sensor. For example, as illustrated in FIG. 14, the sensor 532 can include a light emitting portion 540 and a light receiving portion 542. As such, a beam of light 544 can be emitted from the light emitting portion 540 and received by the light receiving portion 542.

The sensor 532 can be connected to a circuit board, an integrated circuit, or other device for triggering the actuator 534. In the illustrated embodiment, the sensor 532 is connected to an ECU 546. However, other arrangements can also be used. The dispenser 510 can also include a power supply 560. The power supply 560 can be a battery or can include electronics for accepting AC or DC power.

The actuator 534 can be any type of actuator. For example, but without limitation, the actuator 534 can be an AC or DC electric motor, stepper motor, server motor, solenoid, stepper solenoid, or any other type of actuator. Optionally, the actuator 534 can be connected to the pump 518 with a transmitter device 550, such as but not limited to, a coupling and/or drive shaft.

With continued reference to FIG. 14, the dispenser 510 can also include a user input device or a button 552, which can be any type of device allowing a user to input a command into the ECU 546. Furthermore, the dispenser 510 can include a selector device 554, which can be in any type of configuration allowing the user to input a proportional command to the ECU 546 to control an aspect of the operation of the dispenser 510. Additionally, the dispenser 510 can include an indicator device 556 configured to issue a visual, aural, or other type of indication to a user of the dispenser 510.

In operation, the ECU 546 can activate the sensor 532, continuously or periodically, to detect the presence of an object between the light emitting portion 540 and the light receiving portion 542 thereof. The ECU 546 can then actuate the actuator 534 to drive the pump 518 to thereby dispense foam soap from the nozzle 528.

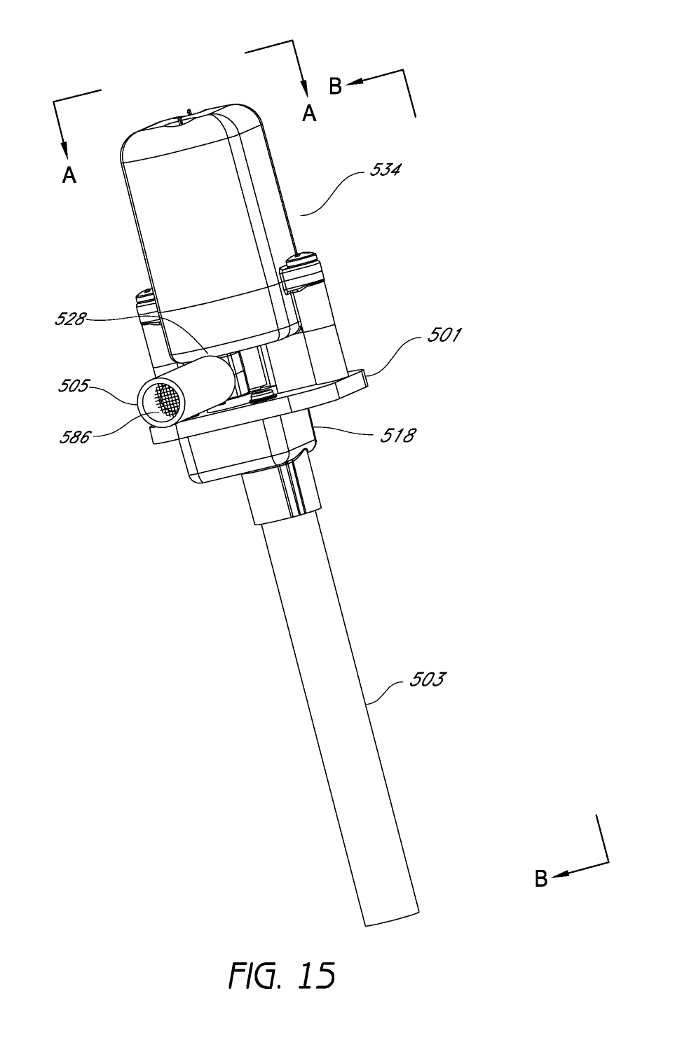

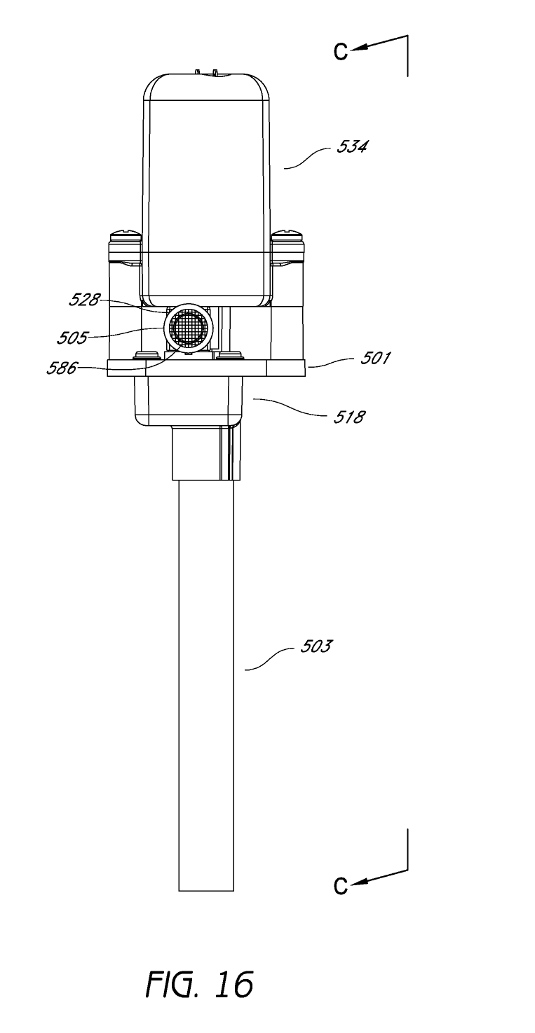

With regard to FIGS. 15 and 16, the illustrated embodiment of the dispenser 510 includes an actuator 534, a pump 518, and a sheath or lumen 503. The actuator 534 can connect to a mount 501, which in turn can connect to the pump 518. The sheath 503 can be generally received in the reservoir (not shown) and connect to the pump 518, thereby facilitating the feeding of liquid soap to the pump 518, as will be discussed further below. A nozzle 528 can also connect to the mount 501 and/or the pump 518. As shown, a shroud 505 can extend from an end of the nozzle 528 and a screen 586 can be received therein.

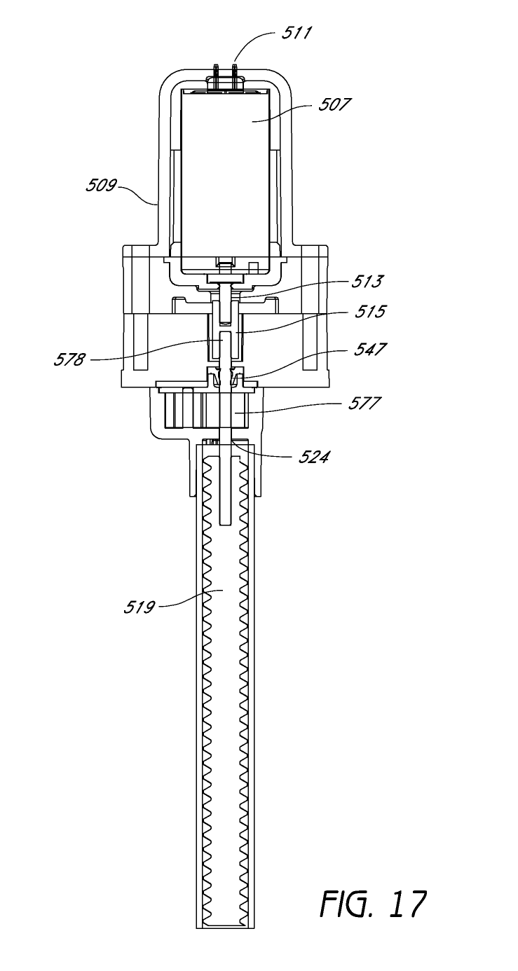

As the embodiment illustrated in FIG. 17, the actuator 534 includes a motor 507 disposed above the mount 501. A protective casing 509 can at least partially enclose and/or provide a liquid tight seal around the motor from the surrounding environment. In some arrangements, a connection point 511 (e.g., an electrical connection) extends from the motor 507 through the casing 509.

Generally, the motor 507 includes a motor shaft 513 that connects to a coupling 515. A drive shaft 578 can also connect to the coupling 515. Thus, rotation of the motor shaft 513 by the motor 507 can be transmitted through the coupling 515 to the drive shaft 578. As shown, the drive shaft 578 can extend downward through a drive shaft aperture 547 in the mount 501. In some embodiments, the drive shaft 578 also extends through and connects to a drive gear 577 of the pump 518. Further, in some embodiments, the drive shaft 578 extends downward from the pump 518 and connects to the feed mechanism 519 disposed at least partially within the sheath 503, which can be in the form of a lumen.

In the illustrated embodiment, the feed mechanism 519 is a worm, screw, or auger. The outside diameter of the feed mechanism 519 is normally near or at an inner diameter of the sheath 503. The feed mechanism 519 can extend the length of the sheath 503 or portions thereof. For example, the illustrated worm extends from about the bottom of the sheath 503 to near the top of the sheath 503. Some embodiments employ a worm with a pitch of about 4-10 threads per inch.

As discussed above, rotational motion of the motor 507 can be transmitted to the drive shaft 578. In turn, the drive shaft 578 can rotate the feed mechanism 519. Often, the motor 507 and/or feed mechanism 519 are sized and configured to rotate at high speed (e.g., 3,000 to 5,000 RPM). Generally, the motor 507 and feed mechanism 519 are directly linked, such as in the embodiment shown. However, other embodiments employ a gear train or the like between the motor 507 and the feed mechanism 519.

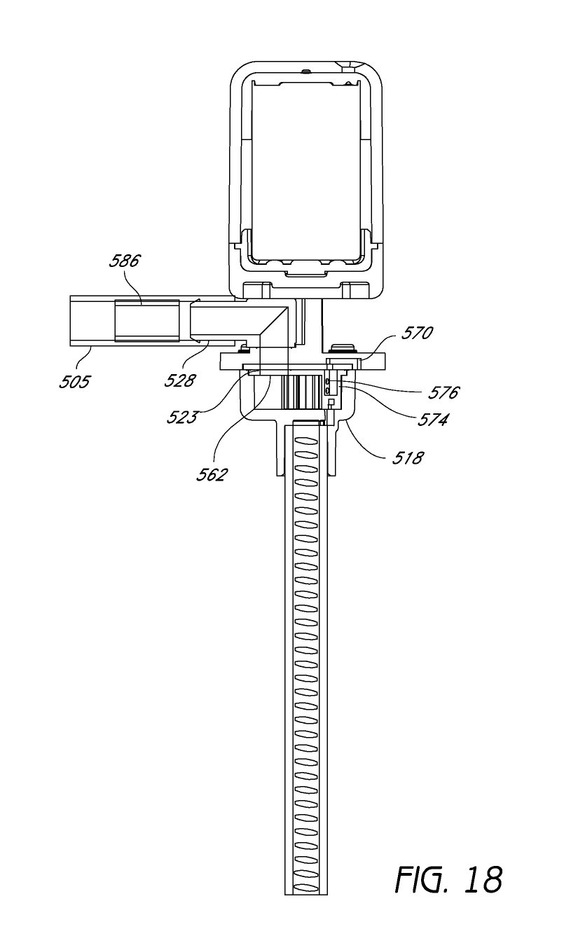

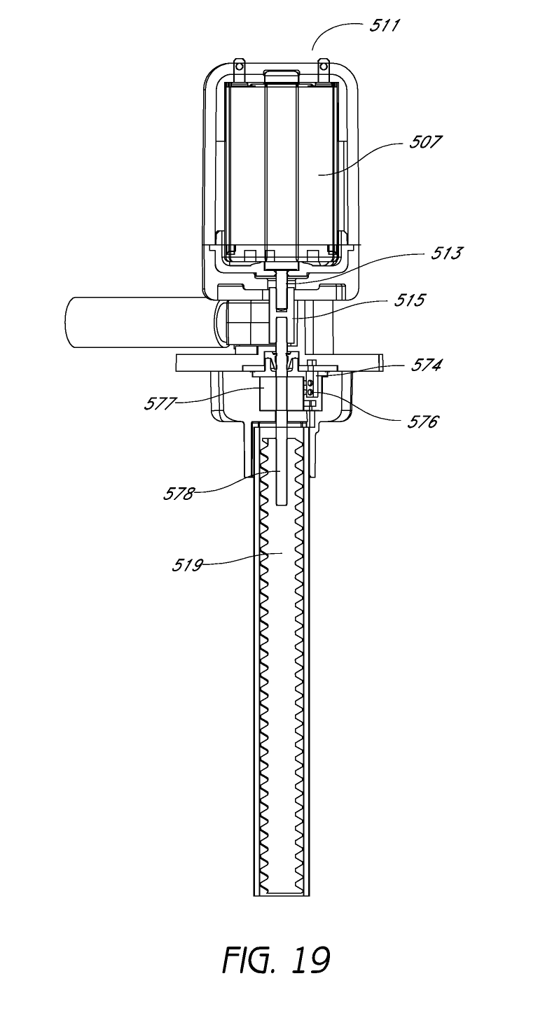

Turning to FIGS. 18 and 19, an air inlet conduit 570 can be disposed through the mount 501 and/or the pump 518. The air inlet conduit 570 can be positioned so as to allow air to pass into the conduit 570 and be communicated to the air nozzle 574 located in the inlet of the pump 518. For example, in some embodiments the air inlet conduit 570 is an elongate recess or lumen formed in a wall of the pump 518, wherein one end of the recess or lumen is open to atmospheric air and the other end of the recess or lumen is in fluid communication with the air inlet nozzle 574. The air inlet nozzle 574 can have a plurality of apertures 576 to permit air to pass from the nozzle 574 to the input of the pump 518.

The pump 518 can include a pump outlet 562. The mount 501 can have a corresponding mount outlet aperture 523 disposed such that, when the mount 501 and pump 518 are connected, the pump outlet 562 and mount outlet aperture 523 are about in line. A nozzle 528 can be partially received by and/or in fluid connection with the pump outlet 562 and mount outlet aperture 523. As shown, the shroud 505 can extend from the end of the nozzle 528 and a screen 586 can be received therein.

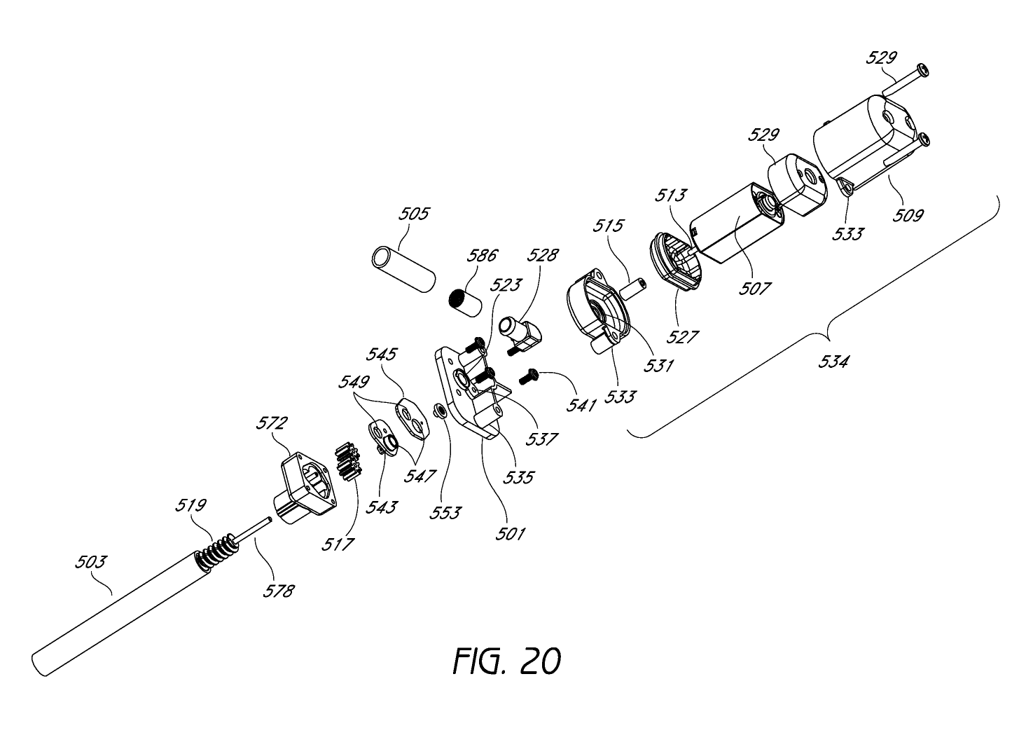

FIG. 20 illustrates an exploded view of the pump 518 as well as other components of the dispenser 510. As shown, the actuator 534 includes the motor 507, a casing 509, and upper and lower motor mounts 525, 527. The casing 509 generally encases the other components of the actuator 534 and can include gaskets and/or seals. In the embodiment shown, the casing 509 is divided into upper and lower portions, which are held together by fasteners 529. The motor mounts 525 and 527 can be configured to reduce vibration and/or noise from the motor 507. Generally, the casing 509 is a metal or hard plastic material and the motor mounts 525, 527 are a pliable and elastic material, such as rubber. The casing 509 can also include an opening 531 disposed in line with the motor shaft 513 and configured to receive the drive shaft 578.

In the embodiment shown, the casing 509 connects to the mount 501 by the fasteners 529 passing through engagement features in the casing 509 and being threadably received by a support feature 535 of the mount 501. As shown, the support feature is an upwardly extending rib that extends about laterally across the mount 501, has a central groove to allow passage of the drive shaft 578, and includes a rearward projection. The mount 501 can include a drive shaft aperture 537, mount outlet aperture 523, and pump connection apertures 539 for coupling the mount 501 and pump 518 with fasteners 541.

Generally, the gear pump 518 includes a pair of gear members 517, a gear pump body 572, a first cover 543, and a second cover 545. The first and second covers 543, 545 can each include a drive shaft aperture 547 and an outlet aperture 549. Generally, when the first and second covers 543, 545 are disposed on the gear pump body 572, the drive shaft apertures 547 and the outlet apertures 549 of the first and second covers 543, 545 are about aligned. In some embodiments, an extension portion 551 can, among other advantages, discourage the covers 543, 545 from moving relative to each other.

In some arrangements, a gasket 553 can be located between the mount 501 and the pump 518. In some cases, the drive shaft 578 passes through the gasket 553.

The pump body 572 normally defines a generally clover and/or partially figure-eight-shaped internal chamber in which the gears 517 rotate. This configuration is well known in the art, and in particular, with regard to devices known as gear pumps. Thus, a further description of the operation of the gear pump 518 is not included herein.

With continued reference to FIG. 20, the drive shaft 578 is shown coupled to the feed mechanism 519, which is received in the hollow sheath 503. The drive shaft 578 can extend through and connect to the drive gear 577 of the pump 518. The drive shaft 578 can also extend through the drive shaft apertures 547 in the covers 543, 545, through the gasket 553, and through the drive shaft aperture 537 in the mount 501. Further, the drive shaft 578 can extend through the opening 531 in the casing 509. As discussed above, the drive shaft 578 can connect to the coupling 515, which is connected to the motor 507. Accordingly, rotation of the motor can rotate the drive shaft 578, which in turn can rotate the drive gear 577 and feed mechanism 519.

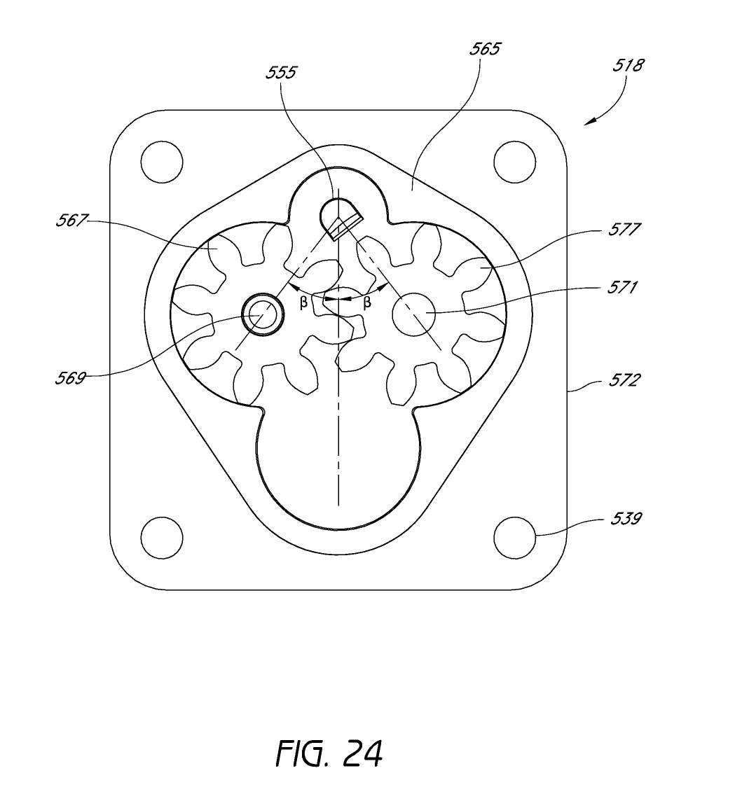

As the lower end of the feed mechanism 519 is normally disposed in the reservoir 516 of liquid soap L, rotation of the feed mechanism 519 transports the liquid soap L vertically, toward the pump 518. For example, in the embodiment shown, rotation of the worm 519 within the sheath 503 encourages liquid soap up the threads of the worm 519 and through the reservoir opening 524. An opening 555 (as shown in FIG. 24) in the lower portion of the gear pump body 572 allows the liquid soap L to enter the internal chamber of the gear pump body 572. In some embodiments, the opening 555 also allows air to enter the internal chamber of the gear pump body 572. In some embodiments, the opening 555 is configured to be large enough so that the drive shaft 578 can extend through the opening 555 while also allowing space for the liquid soap L and/or air to flow through the opening, i.e., between the drive shaft 578 and the periphery of the opening 555.

As is well known in the art of gear pumps, the gears 517 are meshed within the pump chamber 572. Thus, when the drive shaft 578 is rotated to rotate one of the gears 577, the other gear 567 is also rotated. As such, the pump 518 can displace the air and liquid soap L entering the pump body 572 through the air inlet nozzle 574 and/or opening 555 in the pump body 572. The air and liquid soap L are consequently mixed, thereby producing foam soap F. The pump 518 discharges the foam F through the outlet apertures 523, 562 and the nozzle 528.

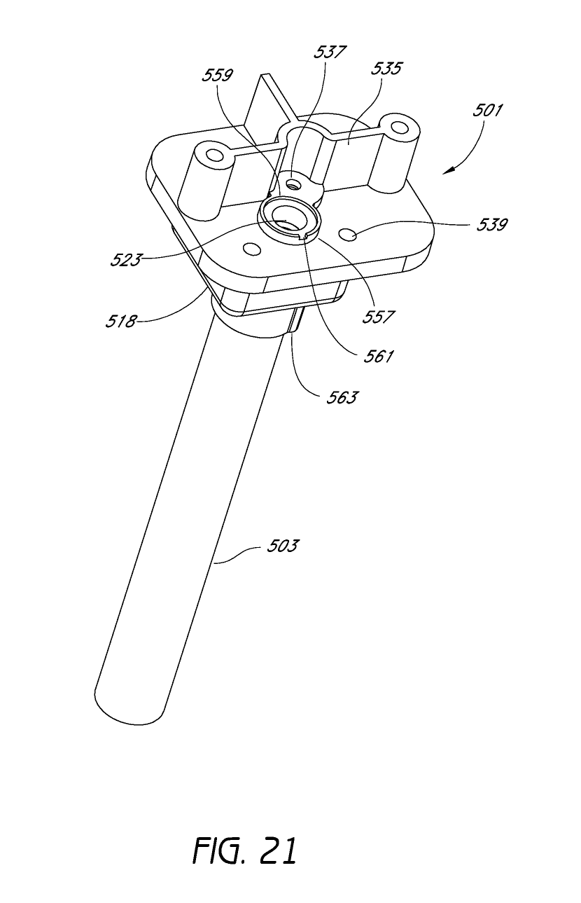

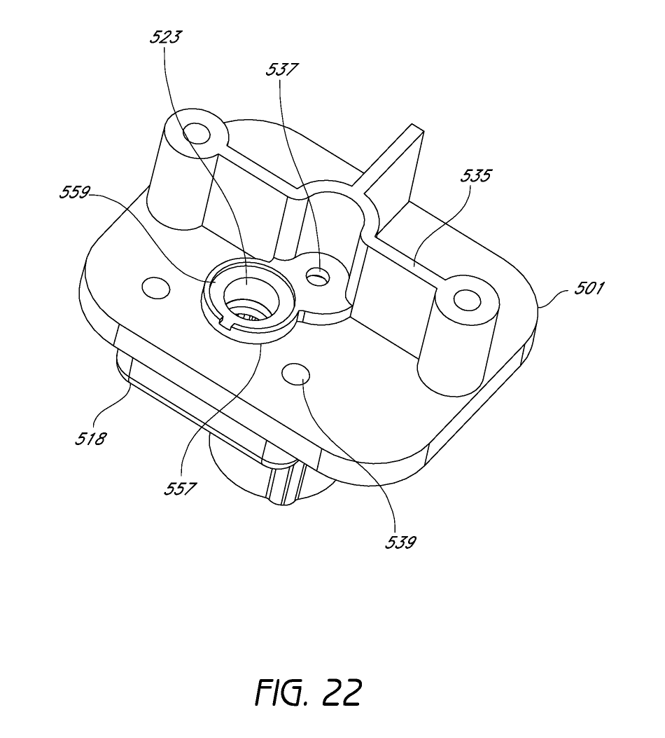

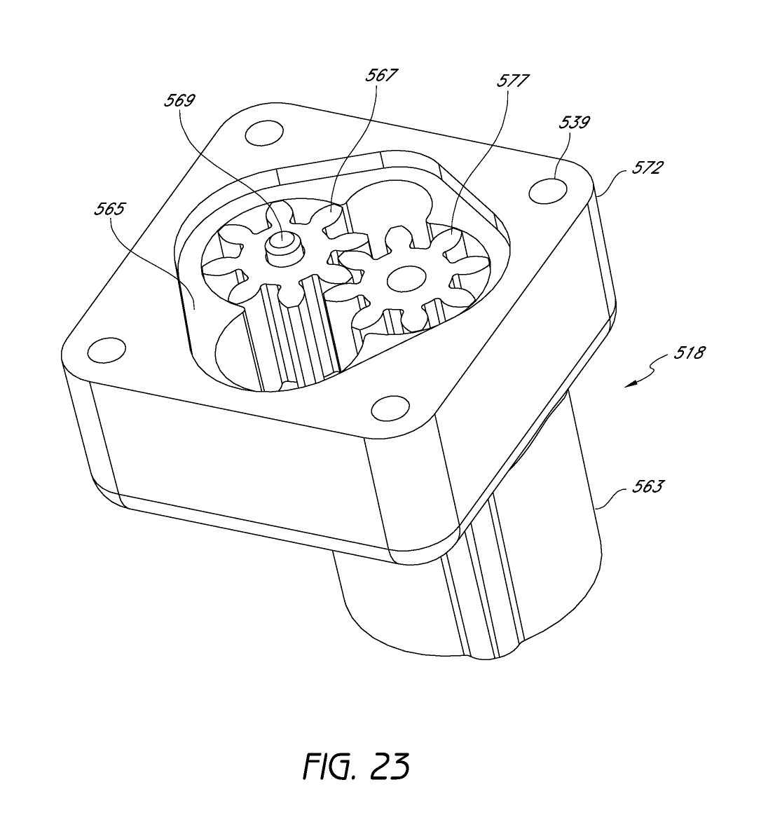

With reference to FIGS. 21 and 22, an embodiment of the mount 501 coupled to the pump 518 is illustrated. Generally, fasteners 541 connect the mount 501 and pump 518 via the pump connection apertures 539, however the fasteners 541 have been omitted from FIGS. 21 and 22 for clarity. As shown, the outlet aperture 523 of the mount 501 can have a raised portion 557, which in turn can have a recessed portion 559 therein. In some embodiments, the raised portion 557 has a notch 561, which can, for example, maintain a desired location of the nozzle 528 when coupled to the mount 501. In the illustrated embodiment, the sheath 503 couples to a downwardly-extending portion 563 of the pump body 572, such as by glue, epoxy, press-fit, or the like. In some embodiments, the air inlet conduit 570 routes between the downwardly-extending portion 563 and the sheath 503. As shown, the downwardly-extending portion 563 can include a radially-expanded portion, which can house at least some of the air inlet conduit 570.

FIGS. 23 and 24 illustrate an embodiment of the pump 518, with the first and second covers 543, 545 removed. As shown, the pump body 572 can have a recessed area 565 configured to receive one or both of the first and second covers 543, 545. In some embodiments the recessed area 565 is configured such that the first and second covers 543, 545 do not protrude above an upper face of the pump body 572.

In the embodiment shown, gears 517 are disposed in the interior chamber of the pump body 572. As discussed above, the drive gear 577 can be coupled to the drive shaft 578, so that rotation of the drive shaft 578 in turn rotates the drive gear 577. The drive gear 577 can also interface with a slave gear 567 such that rotation of the drive gear 577 rotates the slave gear 567 as well. Generally, the slave gear 567 is mounted on a slave shaft 569 that can be formed as a part of and/or rigidly connected to the pump body 572. Normally, the central opening in the drive gear 577 is disposed about over a drive shaft aperture 571 in the pump body 572, thus allowing the drive shaft to extend downwardly toward the feed mechanism 519.

Generally, the air inlet nozzle 574 is disposed over the opening 555 in the pump body 572 so as to allow liquid soap and/or air passing through the opening 555 to enter the interior of the air inlet nozzle 574. In some cases, the liquid soap and/or air encounter a turbulent region within the air inlet nozzle 574, thereby facilitating a mixing of the liquid soap and/or air. Normally, the liquid soap and/or air exit the air inlet nozzle 574 through the apertures 576 and, thus, pass into the input of the gears 517. In some cases, it is advantageous to dispose the apertures 576 at an angle β with respect to longitudinal axis of the gear pump body 572. Such an arrangement can, for example, encourage further mixing of the liquid soap and air. In some embodiments, this angle can be about 35° to 45°. In some embodiments, this angle is about 45° to 60°. In yet further embodiments, this angle is 60° to 75°.

Some embodiments include an aperture 576 on each side of the longitudinal axis of the gear pump body 572, the apertures having angles with respect to longitudinal axis of the gear pump body 572 of β and β′. In some embodiments, β and β′ are the same. However, in other configurations angles β, β′ are different.

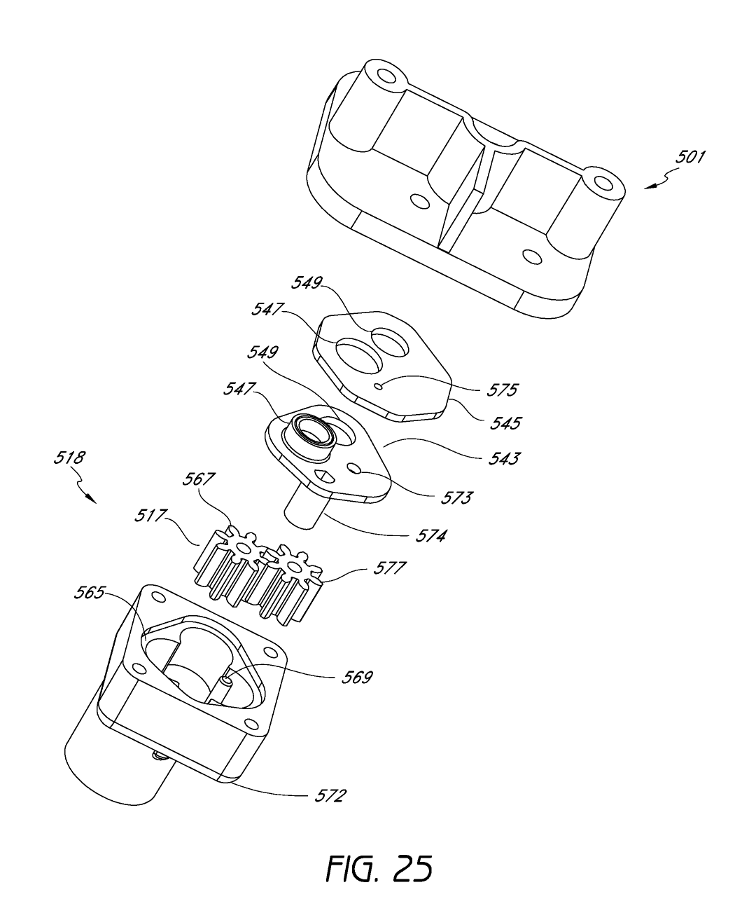

FIG. 25 illustrates an exploded rear view of the pump 518 and mount 501. As shown, the first cover 543 can include the air inlet nozzle 574 configured to be positioned in the inlet of the gears 517 in the assembled state. The first cover can also have a mounting hole 573 to receive the upper end of the slave shaft 569. As previously discussed, the first and second covers 543, 545 can have mating drive shaft apertures 547 and an outlet apertures 549. In some arrangements, the second cover 545 further includes a vent 575 positioned above the air inlet nozzle 574.

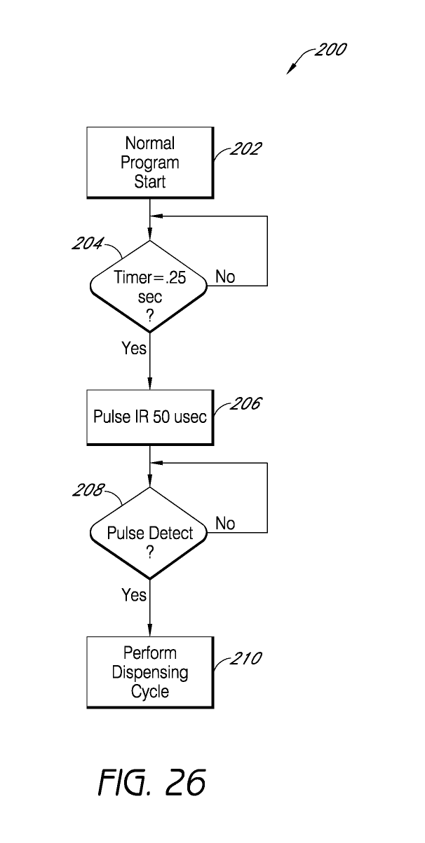

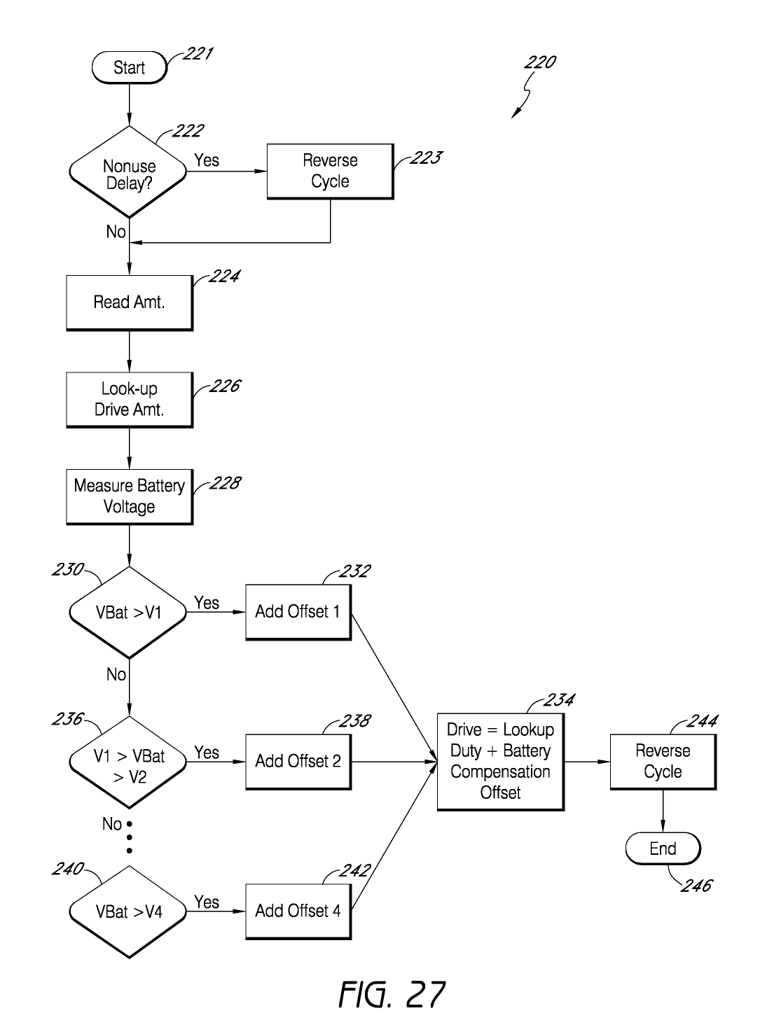

FIG. 26 schematically illustrates a control routine 200 that can be used with any of the dispensers 10, 10A, 510 described above, or with other devices. As noted above, the ECU 46, which can be disposed anywhere in the device 10A, can include modules for controlling various aspects of the operation of the dispenser 10, 10A, 510. The modules described below with reference to FIGS. 26-27 are described in the form of flowcharts representing control routines that can be executed by the ECU 46. However, as noted above, these control routines can also be incorporated into hard wired modules or a hybrid module including some hard wire components and some functions performed by a microprocessor.

With reference to FIG. 26, the control routine 200 can be used to control the actuation of the sensor 32 (FIG. 1) or any other sensor. The control routine 200 is configured to periodically activate the sensor 32, so as to reduce power consumption. Although only sensor 32 is referenced below, it is to be understood that any sensor or combination of sensors can be controlled to reduce power consumption easing the techniques illustrated with reference to the control routine 200.

For example, the control routine 200 can begin operation in the operation block 202. In the operation block 202, the control routine 200 can be started when batteries are inserted into the battery compartment 106, when a power switch (not shown) is moved to an on position, when an AC power source is connected to the ECU 34, or at any other time. After the operation block 202, the routine 200 moves onto a decision block 204.

In the decision block 204, it can be determined whether a timer has reached a predetermined time activation interval. For example, the ECU 46 can include a timer and, initially setting a timer counter value to zero, determine whether the timer has reached a predetermined actuation time interval, such as, for example, one quarter of one second. However, other time intervals can also be used.

If, in the decision block 204, the timer has not reached the predetermined time interval, the routine 200 returns and repeats. On the other hand, if in the decision block 204, the timer has reached the predetermined time interval, the routine 200 moves onto an operation block 206.

In the operation block 206, a sensor can be activated. For example, the ECU 46 can activate the sensor 32. In some embodiments, the ECU 46 can activate the light emitter portion 40 and the light receiver portion 42 of the sensor 32.

In some embodiments, a further advantage can be achieved by activating the sensor 32 for a period of time shorter than the predetermined activation time interval used in decision block 204. For example, in some embodiments, the sensor 32 can be activated for a predetermined duration time period of about 50 microseconds. However, other time periods can also be used.

With the activation duration time period of the operation block 206 being shorter than the predetermined activation time interval of decision block 204, the sensor 32 is not continuously operating. Thus, the power consumption of the sensor 32 can be reduced. When the exemplary embodiment in which the predetermined activation time interval of the sensor block 204 is about ¼ of a second and the duration time period of operation block 206 is 50 microseconds, the sensor 32 is only operating about 0.02% of the time. Thus, a user will only have to wait a maximum of about ¼ of one second before the ETU 46 can detect the activation of the sensor 32.

With regard to the activation of the sensor 32, the ECU 46 can be configured to, as described above, activate the light emitting portion 40 and determine whether or not the light beam 44 has reached the light receiving portion 42. If during such activation, the light receiving portion 42 does not detect the light beam 44, the ECU 46 can determine that the sensor 32 is activated.

For example, after the operation block 206, the routine 200 can move on to a decision block 208 in which it is determined whether or not a pulse of light, such as the light beam 44, has reached the light receiving portion 42. More particularly, for example, the ECU 46 can be configured to absorb the output from the sensor 32 for any interruption of the signal. For example, the ECU 46 can be configured to compare the actuation of the light emitting portion 40 with the signal output from the light receiving portion 42. If there is an interruption, the ECU 46 can determine that a pulse, or an interruption of the light beam 44, has been detected.

If, in the decision block 208, a pulse has not been detected, the routine 200 can return and repeat. Optionally, in some embodiments, the routine 200 can return to a decision block 204 and repeat, although this return is not illustrated in FIG. 26. On the other hand, if it is determined in decision block 208, that a pulse has been detected, the routine 200 can move on to an operation block 210.

In the operation block 210, the routine 200 can perform a dispensing cycle. For example, the ECU 46 can operate the actuator 34 to drive the pump 18 to dispense liquid soap L from the nozzle 28. In some embodiments, the dispensing cycle can also include the step of operating the indicator 56, 56A to provide the user a timer regarding the time over which the use should continue to wash their hands. For example, but without limitation, such a step can include activating the indicator 56, 56A (which can be a visual indicator such as an LED light, for the predetermined time of about 20 seconds, after the pump has completed discharging an amount of soap. However, other steps or methods can also be used.

With reference to FIG. 27, a control routine 220 can be used for performing the dispensing cycle identified in operation block 210 (FIG. 26). However, other control routines can also be used.

With continued reference to FIG. 27, the control routine 220 can be configured to activate certain components of the device 10, 10A, 510 at any time. In some embodiments, for example, the routine 220 can begin an operation block 221 at any time. In some embodiments, the operation block 221 can begin when the ECU 46 detects an interruption of the light beam 44. In other embodiments, the operation block 221 can begin when the ECU 46 detects a sufficient portion of infrared light reflected back. More specifically, for example, but without limitation, the routine 221 can begin if the routine 200 reaches operation block 210. After the operation block 221, the routine 220 can move on to operation block 222.

In the operation block 222, it can be determined if a clearing operation should be performed. If the dispenser 10 has not been used for a specified period of time, then liquid soap L may collect in the nozzle 28. By briefly reversing the pump 18, 18A, liquid soap L as well as remaining foam R can be drawn upstream, deeper into the nozzle 28 or into the outlet conduit 26A.

In operation block 222, the elapsed time since the previous operation of the dispenser 10 is compared to a permissible non-use duration. If the duration since the previous operation is greater than the permissible non-use duration, then the routine 220 moves to operation block 223 to perform the clearing operation, in which the pump 18, 18A is operated in reverse. After the clearing operation, or if the duration since the previous operation is less than or equal to the permissible non-use duration, then the routine 220 can move to operation block 224.

In the operation block 224, the amount of soap to be dispensed can be determined. For example, in the operation block 224, the ECU 46 can sample the output from the selector 54. As noted above, the selector 54 can provide output in the form of two more values. Such values can be a plurality of values or the continuous proportional signal or values proportional to the position of the member 150 (FIG. 6). After the operation block 224, the routine 220 can move on to an operation block 226.

In the operation block 226, the value from the selector 54 can be correlated to a drive amount indicative of the magnitude of actuation that should be applied to the motor 34, 34A. For example, the drive amount can be a value associated with a duration of time over which the motor 34, 34A should be driven, a number of rotations of the output shaft of the motor 34, 34A or another value corresponding to an amount of foam soap F to be discharged from a nozzle 28, 28A. After the operation block 226, the routine 220 can move on to an operation block 228.

In the operation block 228, the voltage of the power source 60, 60A can be detected. For example, the ECU 46 can read the voltage of the power source 60. In some embodiments, the power source 60, 60A is a plurality of batteries. In an exemplary but nonlimiting embodiment, the power source 60A comprises four AA batteries. As is well known in the art, over time, the voltage of such batteries will drop. Thus, by detecting the voltage of these batteries, device 10, 10A, 510 can compensate for drops in voltage over time. For example, the ECU 46 can include an analog to digital converter to sample the voltage of the power supply 60, 60A. Other detectors can also be used. After the operation block 228, the routine 220 can move on to a decision block 230.

In the operation block 230, it can be determined whether the voltage of the power supply 60, 60A is greater than a first predetermined voltage V1. The predetermined voltage V1 can be any voltage.

In some embodiments, the voltage V1 is set at a voltage that corresponds to a substantially fully charged state of the power supply 60, 60A, for example, where the power supply 60, 60A is a disposable or rechargeable battery. Thus, for example, the power supply 60, 60A comprises for AA cell batteries, each rated at 1.5 volts, and thus, the fully charged state of the power supply 60, 60A would be about 6 volts. However, as well known in the art, fully charged AA cell batteries often carry a charge of about 1.6 volts each when they are fully charged and brand new. Thus, the voltage V1 can be 6 or 6.4 volts depending on the level of accuracy desired.

In other words, as described below, the voltage Vbat of the power supply 60, 60A to be compared to several additional voltage thresholds. The more voltage thresholds that are used, the more accurately the ECU 46 can drive the actuator 34 so as to provide a consistent speed of discharge of foam soap F from the nozzle 28, 28A.

With continued reference to a decision block 230, if it is determined that the voltage Vbat of the power supply 60, 60A is greater than the first predetermined voltage threshold V1, the routine 220 can move on to an operation block 232.

In the operation block 232, an offset value can be determined. For example, the offset value 1 can be predetermined to achieve a desired speed of the pump 18, 18A. In some embodiments, the magnitude of the value offset 1 can be the largest of offset values.

For example, in some embodiments, the value of offset 1 can be −30%. As such, when the voltage Vbat of the power supply 60, 60A is at its greatest value, and largest (negative) offset is applied. As such, the voltage Vbat of the power supply 60, 60A is at its greatest value, and largest (negative) offset is applied. As such, the voltage Vbat of the power supply 60, 60A drops over time, smaller (negative) offset values can be applied to thereby achieve a substantially uniform speed of the pump 18, 18A and thus are substantially uniform speed of discharge of foam soap F, nozzle 28, 28A, as the voltage of the power supply 60, 60A discharges over time. After the operation of block 232, the routine 220 can move to operation block 234.

In the operation block 234, the drive value determined in operation block 226 is added with the offset value, at this point when the routine 220, the drive value is added toward the value offset 1. Thus, in an embodiment where the values of Offset 1 is −30%, the drive value claimed in operation block 226 is reduced by 30%. Thus, in the operation block 334, the motor or actuator 34 is driven at this resulting drive value.

With regard to the drive value applied to the actuator 34, the power output from the power supply 60, 60A can be varied in any known way. For example, where the drive power signals applied to the motor 34A are in the form of a duty cycle, characteristics of the duty cycle can be varied to achieve a varying power applied to actuator 34. For example, but without limitation, the pulse width of the duty cycle applied to the actuator 34 can be increased or decreased. However, there is a maximum point of adjustment for an electric motor, such as the motor 34. Thus, the maximum adjustment allowed by the technique used to adjust power output as the motor 34 would be considered a 100% drive value.

In reference again to the decision block 230, if it is determined that the voltage of the power supply Vbat is not greater than V1, and the routine 220 moves to operation block 236.

In the decision block 236, it can be determined whether the voltage of the battery Vbat is less than the voltage V1 and greater than another predetermined voltage V2. As noted above, with regard to the description of the voltage V1, the voltage V2 can be set at a voltage indicative of a voltage normally reached by a power supply as the battery cells discharge but are still useful. First, it is determined in the decision block 236, that the voltage Vbat is less than the voltage V1 but greater than the voltage V2, the routine can move on to operation block 238.

In the operation block 238, another offset value can be determined. For example, in the operation block 238, the offset can be determined as Offset 2. In an exemplary but nonlimiting embodiment, the value of Offset 2 can be −20%. As such, as noted above, as the voltage of the power supply 60, 60A drops, the magnitude of the offset value drops (to a smaller negative value) thereby compensating for the decrease in voltage of the power supply 60, 60A. After the operation block 238, the routine 220 can move on through operation block 234 and continues as described above.

With reference again to decision block 236, if the determination therein is negative, the routine can move on to other decision blocks. There can be any number of decision blocks similar to the decision block 230, 236, depending on how many steps or stages of the discharge state of the power supply 60, 60A are contemplated.

Decision block 240 represents an exemplary final decision block that can be used in the series. In the decision block 240, it can be determined whether the voltage Vbat of the power supply 60, 60A below a final reference voltage V4. The final reference voltage V4 can be a voltage below which there is very little use for power left in the power supply 60 below a final reference voltage V4. The final reference voltage V4 can be a voltage below which there is very little use for power left in the power supply 60, 60A, and shutdown of the ECU 46 is imminent. However, other reference voltages can also be used. If, in the decision block 240, it is determined that the voltage Vbat is less than the reference voltage V4, the routine 220 moves on to operation block 242.

In the operation block 242, a final offset value Offset 4 can be determined. In some exemplary, but nonlimiting embodiments, the offset value offset 4 is 0%. Thus, for example, the full value of the drive value determined in the operation block 226 is applied to the actuator 34, in the operation block 234. However, in some embodiments, the value of Offset 4 can be a value that will result in a 100% value for the drive value. After the operation block 234, the routine 220 can move on to operation block 244.

In the operation block 244, the ECU 46 can operate the actuator 34 in reverse, to thereby reverse operation of the pump 18, 18′. The amount of actuation of the actuator 34, 34A can be predetermined to provide sufficient movement of foam soap (U, R FIG. 13), backwards toward and/or along the nozzle 28 and conduit 26, 26A such that remaining foam R does not drip from the nozzle 28, 28A. This amount of actuation of the actuator 34, 34A can be determined through routine experimentation. Additionally, the amount of actuation of the actuator 34, 34A can be varied based on battery voltage, the performance characteristics of the pump 18, 18′, as well as other parameters and considerations, such as those noted above, but without limitation, in the routine 220 with regard to the discharge of a foam soap F from a nozzle 28, 28A.

After the operation block 244, the routine 220 can move on to operation block 246. Thus, each time the routine 200 (FIG. 26) reaches operation block 210 which is described as the performance of dispensing cycle, the routine 220 can operate, provide a substantially uniform dispensations of foam soap F, regardless of battery voltage, then reverse the flow of foam soap (U, R, F) therein to prevent dripping, and then end.

Additionally, in some embodiments, the device 10, 10A, 510 can include another timer, which can be in the form of another control routine (not shown) to prevent the routine 220 from being repeated within a predetermined time period. For example, this timer or control routine can prevent the repeat of operation block 220 within two seconds. As such, there is at least a two-second delay between dispensation cycles. However, other predetermined time periods can also be used.

Although this invention has been disclosed in the context of a certain preferred embodiment and examples, it will be understood by those skilled in the art that the present invention extends beyond the specifically disclosed embodiment to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiment can be combined with or substituted for one another in order to form varying modes of the disclosed invention. Thus, it is intended that the scope of the present invention herein-disclosed should not be limited by the particular disclosed embodiments described above, but should be determined only by a fair reading of the claims that follow.

What is claimed:

1. A foamed soap dispenser, comprising:
a reservoir configured to store liquid soap;
a gear pump comprising pump chamber having a gear pump inlet and a gear pump outlet, a liquid soap inlet connected to the reservoir so as to guide liquid soap from the reservoir to the gear pump inlet of the pump chamber, an air inlet configured to allow air to flow into the gear pump inlet of the pump chamber, and a pair of pump gears meshed with each other and disposed in the pump chamber; and
a motor configured to drive the gear pump;
wherein liquid soap and air are mixed in the pump chamber by the meshed pump gears when the gear pump is driven by the motor.

2. The foamed soap dispenser of claim 1 additionally comprising a trigger sensor configured to detect the presence of an object; an electronic control unit connected to the trigger sensor and to the motor, the electronic control unit configured to actuate the motor upon receiving a signal from the trigger sensor, until an amount of foam soap has been ejected from the nozzle.

3. The foamed soap dispenser of claim 2 wherein the electronic control unit is configured to dispense an amount of foam soap only after a predetermined time period has elapsed from a previous ejection of foam soap.

4. The foamed soap dispenser of claim 1 additionally comprising a feed pump having a feed pump inlet and a feed pump outlet, the feed pump inlet being positioned to be in fluidic communication with liquid soap in the reservoir, the feed pump outlet being in fluidic communication with liquid soap inlet so as to guide liquid soap from the feed pump outlet into the liquid soap inlet.

5. The foamed soap dispenser of claim 4, wherein the motor drives both the gear pump and the feed pump.

6. The foamed soap dispenser of claim 4, wherein the feed pump comprises an auger.

7. The foamed soap dispenser of claim 4, wherein the motor is disposed at least partially above the gear and feed pumps and the gear and feed pumps are disposed at least partially above the reservoir.

8. The foamed soap dispenser of claim 4, wherein the feed pump comprises a screw and hollow sheath.

9. The foamed soap dispenser of claim 1, wherein the air inlet is connected to a conduit having an end disposed above a fill line of the reservoir.

10. The foamed soap dispenser of claim 1, wherein the air inlet is exposed to about ambient air pressure.

11. The foamed soap dispenser of claim 1, wherein the air inlet and the liquid soap inlet are sized to produce a volumetric air to liquid soap ratio of about 4 to 1 when the gear pump is driven by the motor.

12. The foamed soap dispenser of claim 1, further comprising a collection reservoir for condensed foam, the collection reservoir being formed by a proximal end of an inner surface of the discharge nozzle that terminates at an elevation that is lower than a dispensing end of the inner surface of the discharge nozzle.

13. The foamed soap dispenser of claim 2, wherein the electronic control unit is configured to reverse the pump after a predetermined amount of foamed soap has been dispensed, thereby drawing foamed soap in the soap conduit backwards away from the nozzle to prevent dripping.

14. An electric foamed soap dispenser, comprising:
a reservoir configured to store liquid soap;
a first pump comprising a first pump outlet, a first liquid soap inlet, and a first air inlet configured to allow air to flow into the first pump, the first air inlet and the first liquid soap inlet being disposed above a maximum fill elevation for liquid soap in the reservoir;
a motor configured to drive the first pump; and
a second pump having a second liquid soap pump inlet disposed below the maximum fill elevation, and a second pump outlet in fluidic communication with the first liquid soap inlet of the first pump;
wherein liquid soap entering the first pump through the first liquid soap inlet is mixed with air entering the first pump from the first air inlet into foamed soap when the first pump is driven by the motor.

15. The foamed soap dispenser of claim 14, wherein at least one of the first pump, the second pump, and the reservoir are configured such that at least some foamed soap condenses and is returned to the reservoir by gravity.

16. The foamed soap dispenser of claim 14, wherein the first air inlet and the first liquid soap inlet are disposed above a maximum fill elevation of the reservoir.

17. The foamed soap dispenser of claim 14, wherein the motor is disposed at least partially above the first and second pumps and the first and second pumps are disposed at least partially above the reservoir.

18. The foamed soap dispenser of claim 14, wherein the second pump comprises an auger and a lumen.

19. The foamed soap dispenser of claim 14, wherein the motor drives a single drive shaft that drives both the first pump and the second pump.
